(19) United States
(12) Patent Application Publication
(10) Pub. No.: US 2010/0023426 A1
(43) Pub. Date: Jan. 28, 2010

(54) DISTRIBUTED MATCHING SYSTEM FOR COMPARING GARMENT INFORMATION AND BUYER INFORMATION EMBEDDED IN OBJECT METADATA AT DISTRIBUTED COMPUTING LOCATIONS

(75) Inventors: Louise J. Wannier, Pasadena, CA (US); James P. Lambert, Toluca Lake, CA (US); Eric Jennings, Reno, NV (US); Mercedes De Luca, Saratoga, CA (US); Louisa Anna Simpson, Pasadena, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: myShape, Inc., Pasadena, CA (US)

(21) Appl. No.: 12/510,198

(22) Filed: Jul. 27, 2009

Related U.S. Application Data
(60) Provisional application No. 61/084,155, filed on Jul. 28, 2008.

(51) Int. Cl. G06Q 30/00; G06F 17/30; G06Q 50/00

(52) U.S. Cl. 705/27; 707/5; 707/10; 707/E17.044; 707/E17.014; 707/E17.017; 707/E17.032

(57) ABSTRACT

An online garment selection and acquisition system comprises at least a server computer system that receives requests from client computer systems and/or client devices and responds to those requests, wherein the server computer system is configured to be able to access a database system for reading data therefrom in order to provide matching of garments and consumers according to a set of computer-readable rules and an application that applies those rules. The application can execute in a distributed manner, such as where the garment data is embedded in images or objects that are presented to the consumer (or consumer representative), such as being shown as web pages, and the application executes at a computer presenting the web page and/or the consumer computer.

### CROSS-REFERENCE TO RELATED APPLICATIONS

This application claims benefit under 35 USC §119(e) of U.S. Provisional Patent Application No. 61/084,155 filed Jul. 28, 2008, which is herein incorporated by reference in its entirety for all purposes.

The present disclosure may be related to the following commonly assigned applications/patents:
U.S. Pat. No. 7,398,133 entitled “Matching the Fit of Individual Garments to Individual Consumers” issued to Wannier et al. (hereinafter “Wannier I”);
U.S. patent application Ser. No. 11/697,688, filed Apr. 6, 2007, entitled “Computer System for Rule-Based Clothing Matching and Filtering Considering Fit Rules and Fashion Rules” in the name of Wannier et al. (hereinafter “Wannier II”);
U.S. patent application Ser. No. 12/433,830, filed Apr. 30, 2009, entitled “System and Method for Networking Shops Online and Offline” in the name of Wannier et al. (hereinafter “Wannier III”);
U.S. patent application Ser. No. 12/494,242 filed Jun. 29, 2009, entitled “System and Method for Networking Shops Online and Offline” in the name of Wannier et al. (hereinafter “Wannier IV”);
U.S. patent application Ser. No. 12/494,244 filed Jun. 29, 2009, entitled “System and Method for Networking Shops Online and Offline” in the name of Wannier et al. (hereinafter “Wannier V”); and
U.S. Provisional Patent Application No. 61/091,334 filed Aug. 22, 2008, entitled “System and Method to Identify and Visually Distinguish Personally Relevant Items” in the name of Wannier et al. (hereinafter “Wannier VI”).

The respective disclosures of these applications/patents are incorporated herein by reference in their entirety for all purposes.

### FIELD OF THE INVENTION

The present invention relates generally to computer systems for providing consumer access to databases of clothing items and in particular to computer systems that programmatically match clothing items with individual consumers' data, possibly including searching, sorting, ranking, and filtering database items from a plurality of partners.

### BACKGROUND OF THE INVENTION

Consumers often have difficulties finding apparel that fits and flatters. III-fitting garments do not sell and are often returned when they do sell. One cause of fit problems is a lack of standards. Without standardization, the garment size for an individual often differs from one brand of apparel to another. There have been multiple attempts to establish commercial standards for sizing garments. Clothing manufacturers and retailers have repeatedly redefined the previous standards or invented their own proprietary sizing schemes. Even within a single size from a single manufacturer, there can be fit problems because of a wide variation in consumers' body shapes. The lack of sizing standards combined with unreliable labeling can cause apparel fit problems, which in turn causes a very high rate of apparel returns, lost sales, brand dissatisfaction, time wasted in fitting rooms, and intense consumer frustration.

As more consumers rely on online information about products for purchase, more merchants provide electronic access to information about goods and services over the Internet. Typically, a merchant compiles a database of products and/or services, which may include information about a product's size, color, type, description, price, etc. Consumers can view the merchant's offerings over the Internet, select items of interest, and place orders with the merchant's interface.

Online shopping is significantly restricted compared to visiting a store in person. The consumer has no direct contact with the product. Where the product has a greater personal impact, such as fit, this shortcoming has more significance. For example, in fashion shopping, ordering clothing, accessories, shoes, purses, and any products incorporating a style sense, online shopping is limited. Fashion intrinsically includes shopping and purchasing something that is new and different. In clothing shopping, without the actual garment to see and try on, there is no way to visualize how the article matches a particular fashion sense or fits.

A number of approaches have been tried to bridge the gap between online shopping for clothing, shoes, or other fashion items and having the item in hand to try on. One approach has been to custom tailor the article of clothing from the customer's measurements. Other approaches have incorporated a scanned image of the customer with a geometric model of a garment that, when combined through computer graphic techniques, provides an image of the consumer wearing the garment. A further system relates photographic color systems to a color classification scheme. Colors may be automatically grouped by a fashion type, stylist, or particular color palette. One system categorizes women into “winter, summer, fall, spring” color palettes, based on their skin, eye and/or hair colors.

Another attempt to solve these challenges involves analyzing a large market population and producing a garment's design based on a corresponding range of sampled body shapes. From this, manufacturers tend to produce a particular pant in several body shapes to offer fit choices corresponding to the sampled body shapes. This approach relies on trial and error by the consumer to locate and determine good fitting pants. Some online solutions have several stores trying to interrelate with one another through portals and cross-linked access to each affiliate's Web site. Customer's are often confused or lost by excursions through these portals.

An improved system and method for providing clothing choices to consumers and other individuals is needed.

### BRIEF SUMMARY OF THE INVENTION

An online garment selection and acquisition system comprises at least a server computer system that receives requests from client computer systems and/or client devices and responds to those requests, wherein the server computer system is configured to be able to access a database system for reading data therefrom in order to provide matching of garments and consumers according to a set of computer-readable rules and an application that applies those rules. The application can execute in a distributed manner, such as where the garment data is embedded in images or objects that are presented to the consumer (or consumer representative), such as being shown as web pages, and the application executes at a computer presenting the web page and/or the consumer computer.

A typical system might comprise a database system that includes a database server and a database for an inventory of garments, wherein the database includes a plurality of type parameters for garments in the inventory and at least at least one fit, shape, preference or style parameter, and wherein the database is distributed over a plurality of database servers, a network interconnecting the plurality of database servers to the client computer systems and/or devices, program code for generating metadata for garments to be embedded in images of the garments, program code for obtaining consumer data including one or more of consumer body shape, consumer proportion, consumer preferences, program code for filtering the collection of garments according to one or more of consumer preference, consumer size, consumer measurements, consumer shape and parameters of the garments in the database to form a personalized selection of garments, and program code for generating a presentation of at least one image of a garment to allow for a consumer or consumer representative using the client computer systems and/or client devices to select and/or acquire the garment, wherein the image includes metadata usable for the program code for filtering.

The following detailed description together with the accompanying drawings will provide a better understanding of the nature and advantages of the present invention.

### BRIEF DESCRIPTION OF THE DRAWINGS

FIG. 1 is an illustration of a clothes shopping system, in accordance with described embodiments.

FIG. 2 is a simplified block diagram of a consumer-garment matching method, in accordance with described embodiments.

FIG. 3 is a simplified block diagram of a definition process, in accordance with described embodiments.

FIGS. 4A-D illustrate height and length measurement techniques, in accordance with described embodiments.

FIGS. 5A-B are simplified block diagrams of a categorization process, in accordance with described embodiments; FIG. 5A shows a consumer recording process and FIG. 5B shows a garment recording process.

FIG. 6 is a simplified block diagram of a match assessment process, in accordance with described embodiments.

FIGS. 7-13 are flowcharts illustrating a match assessment process for a fitted dress, in accordance with described embodiments.

FIG. 14 is an illustration of example output from a match assessment process, in accordance with described embodiments.

FIG. 15 is an illustration of a garment display interface, in accordance with described embodiments.

FIGS. 16-18 are illustrations of clothes shopping systems, in accordance with described embodiments.

FIG. 19 is a block diagram of a linked lists creation process in accordance with described embodiments.

FIG. 20 is an illustration of a clothes shopping system, in accordance with described embodiments.

FIG. 21 is a block diagram of an outfit presentation process in accordance with described embodiments.

FIGS. 22-24 are block diagrams of a body shape, consumer, and garment categorization processes, in accordance with embodiments of the invention.

FIG. 25 is an illustration of a match system, in accordance with embodiments of the invention.

FIG. 26 is an illustration of a clothes shopping system, in accordance with described embodiments.

FIG. 27 is a block diagram of a preferred fashion presentation process in accordance with described embodiments.

FIGS. 28-30 are block diagrams of a fashion product and accessory presentation and recommendation processes in accordance with described embodiments.

FIG. 31 is a block diagram of an altered garment presentation process in accordance with described embodiments.

FIG. 32 is a block diagram of a garment profiling process in accordance with described embodiments.

FIG. 33 is an illustration of a clothes shopping system, in accordance with described embodiments.

FIGS. 34-36 are block diagrams of a user shopping update process in accordance with described embodiments.

FIG. 37 illustrates metadata structure of a garment image and of a consumer image.

FIG. 38 illustrates an exemplary searching process

FIG. 39 illustrates an exemplary process for the metadata use of RFID tags.

### DETAILED DESCRIPTION

An improved online clothes shopping system is described herein, where a consumer is presented with a personalized online store that lists clothing items for sale that are most likely to fit and flatter the consumer and match their preferences for style. The presented list of items can be generated by a computerized garment-consumer matching method that matches the fit and fashion of individual clothing items to individual consumers.

Clothing items are commonly thought to include garments (dresses, coats, pants, shirts, tops, bottoms, socks, shoes, bathing suits, capes, etc.), but might also include worn or carried items such as necklaces, watches, purses, hats, accessories, etc. In any of the following examples, sized and fitted garments are the items being shopped for, but it should be understood that unless otherwise indicated, the present invention may be used for shopping for other clothing items as well. As used herein, an outfit is a collection of two or more clothing items intended to be worn or used together.

In describing embodiments of the invention, female consumers and women's apparel will serve as examples. However, the invention is not intended to be limited to women's apparel as the invention may be used for various types of apparel including men's and children's apparel. Throughout this description the embodiments and examples shown should be considered as exemplary rather than limitations of the present invention.

In a matching process, garments and consumers are compared. For garments, the measurements, style/proportion and attributes (color, weave, fabric content, price, etc.) might be taken into account, while for the consumer, measurements, body proportion (such as shape code), and consumer fit, style, and fashion preferences (how snug/loose, color, classic/contemporary/romantic, etc.), may be considered.

Fashion rules can be defined for various garment style(s) that suit body proportions, for garments and outfits, including accessorizing. Fashion rules (programmatically defining fashion expertise) can be “overlaid” on the matches to recommend the best combinations that will fit and flatter. In this manner, a consumer is presented with a number of garments to choose from, where each is likely to be a “good choice”, while 1 garments that are less likely to fit or flatter our left out. There could be a wide variety of garments and styles, etc., but they are organized as a personal store for that consumer.

### Clothes Shopping System

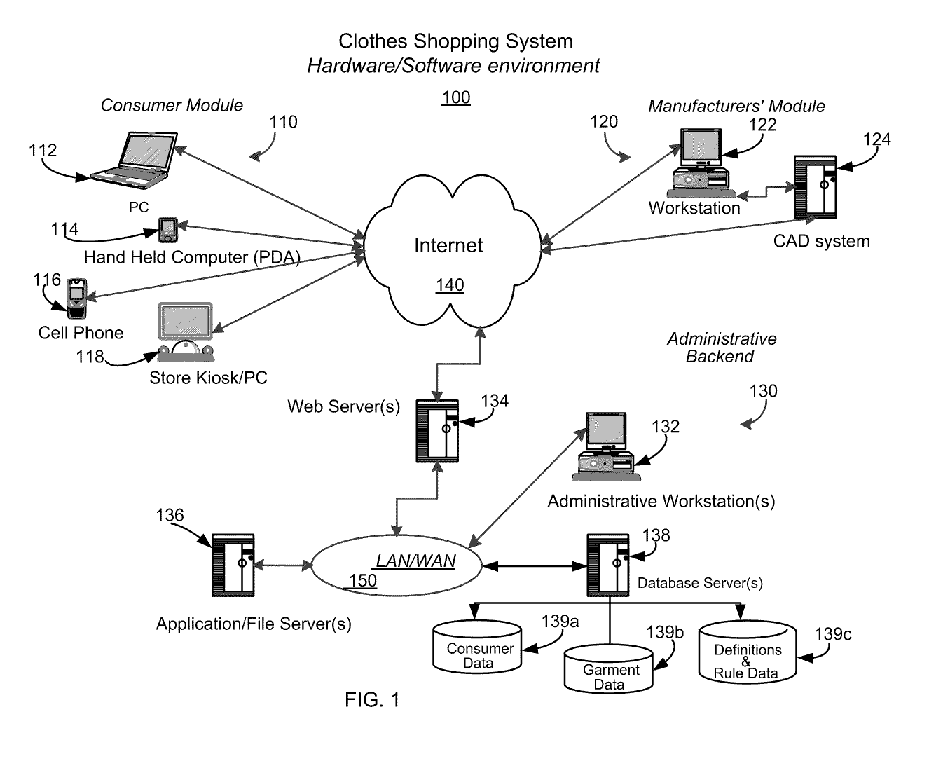

FIG. 1 is a high-level diagram depicting a clothes shopping system 100, which can be a computer implementation of a consumer-garment matching method in accordance with one embodiment of the present invention. The clothes shopping system can be client-server system, i.e., an assemblage of hardware and software for data processing and distribution by way of networks, as those with ordinary skill in the art will appreciate. The system hardware may include, or be, a single or multiple computers, or a combination of multiple computing devices, including but not limited to: PCs, PDAs, cell phones, servers, firewalls, and routers.

As used herein, the term software involves any instructions that may be executed on a computer processor of any kind. The system software may be implemented in any computer language, and may be executed as compiled object code, assembly, or machine code, or a combination of these and others. The software may include one or more modules, files, programs, and combinations thereof. The software may be in the form of one or more applications and suites and may include low-level drivers, object code, and other lower level software.

The software may be stored on and executed from any local or remote machine-readable media, for example without limitation, magnetic media (e.g., hard disks, tape, floppy disks, card media), optical media (e.g., CD, DVD), flash memory products (e.g., memory stick, compact flash and others), Radio Frequency Identification tags (RFID), SmartCards™, and volatile and non-volatile silicon memory products (e.g., random access memory (RAM), programmable read-only memory (PROM), electronically erasable programmable read-only memory (EEPROM), and others), and also on paper (e.g., printed UPC barcodes).

Data transfer to the system and throughout its components may be achieved in a conventional fashion employing a standard suite of TCP/IP protocols, including but not limited to Hypertext Transfer Protocol (HTTP) and File Transfer Protocol (FTP). The eXtensible Markup Language (XML), an interchange format for the exchange of data across the Internet and between databases of different vendors and different operating systems, may be employed to facilitate data exchange and inter-process communication. Additional and fewer components, units, modules or other arrangement of software, hardware and data structures may be used to achieve the invention described herein. An example network is the Internet, but the invention is not so limited.

In one embodiment, a clothes shopping system 100 comprising of a consumer module 110, a manufacturer module 120, and an administrative backend 130, all networked over local and/or wide area networks (LAN/WAN) 150, and the Internet 140. The administrative backend 130 uses administrator workstations 132, web servers 134, file and application servers 136, and database servers 138 that incorporate consumer-garment matching software, the consumer and garment record databases 139a-139b, definition & rules database 139c. The manufacturer module 120 uses software/hardware that allows a manufacturer to input data into the garment records. This data may be entered via a workstation 122 or by interfacing with the manufacturer's internal systems, such as CAD systems 124. This inputted garment data is subjected to a categorization process 220. The consumer module 110 is accessed via personal computers at home, office 112, or by cellular phones 116, PDAs 114, and kiosks 118.

### The Consumer-Garment Matching Method

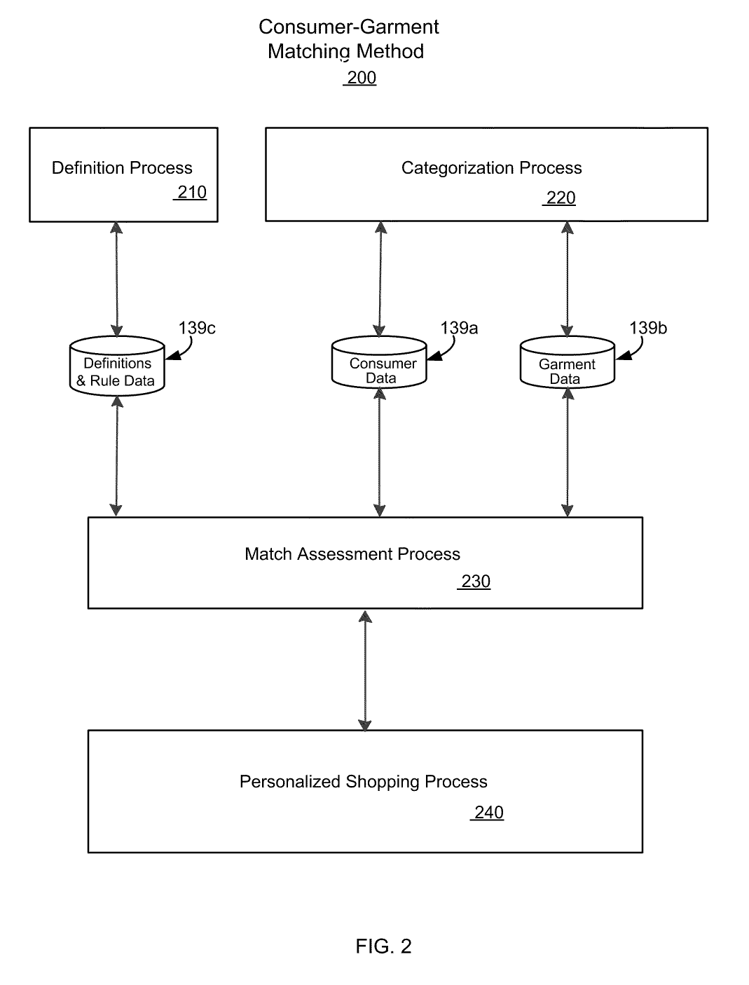

FIG. 2 is a simplified block-diagram depicting a consumer-garment matching method 200 and the data inputs, outputs and interdependence of its constituent processes: a definition process 210, a categorization process 220, a match assessment process 230, and a personalized shopping process 240, described herein.

### Definition Process

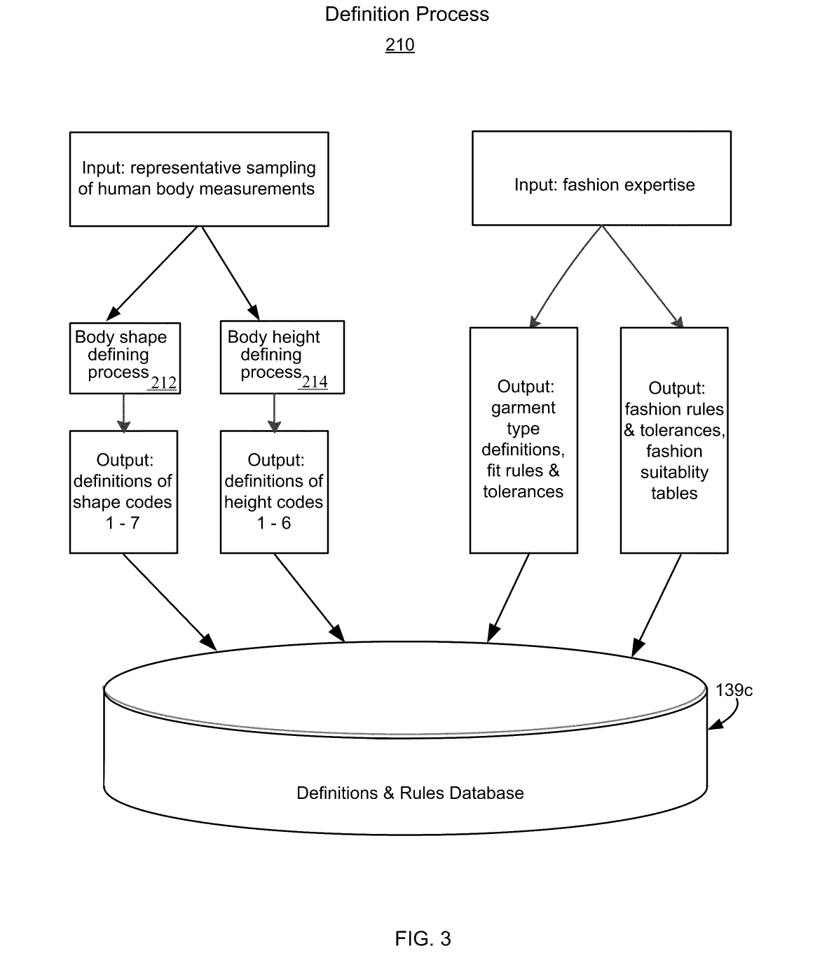

FIG. 3 depicts a definition process 210. Sets of measurements may be used by the categorization process 220 when collecting body measurement data from any individual consumer via the consumer module 110.

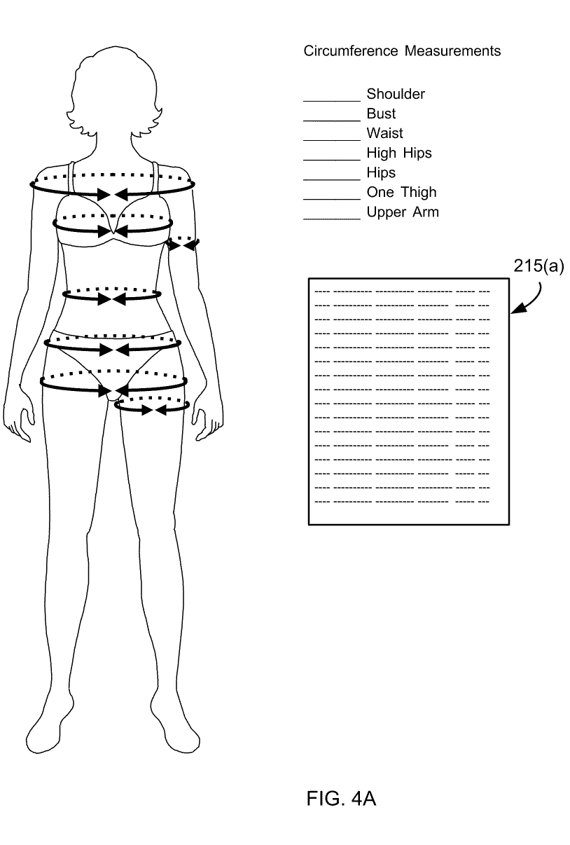

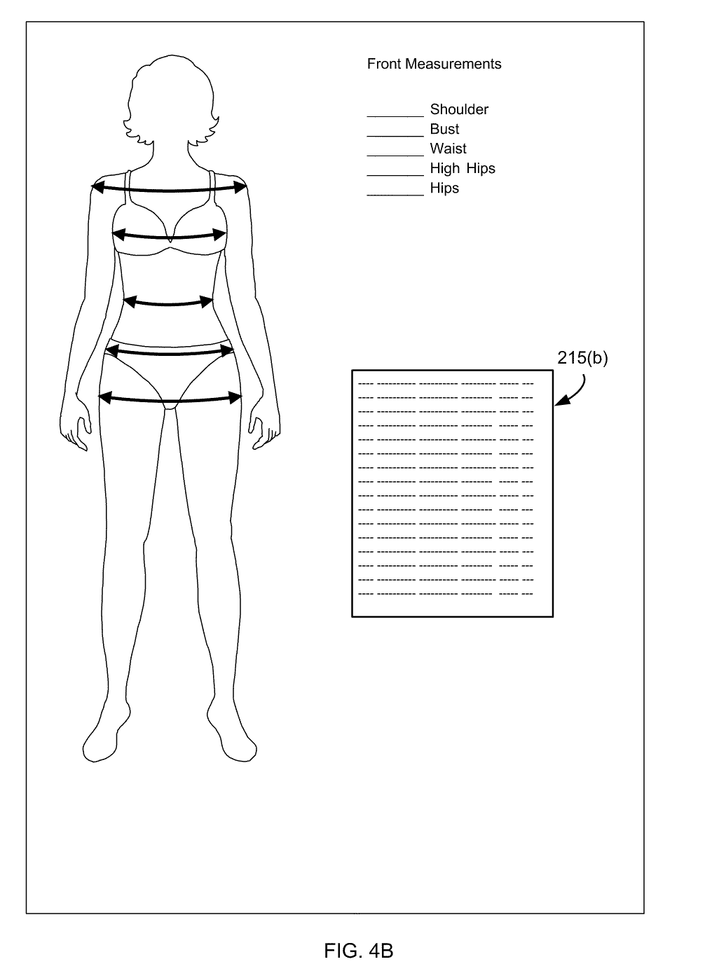

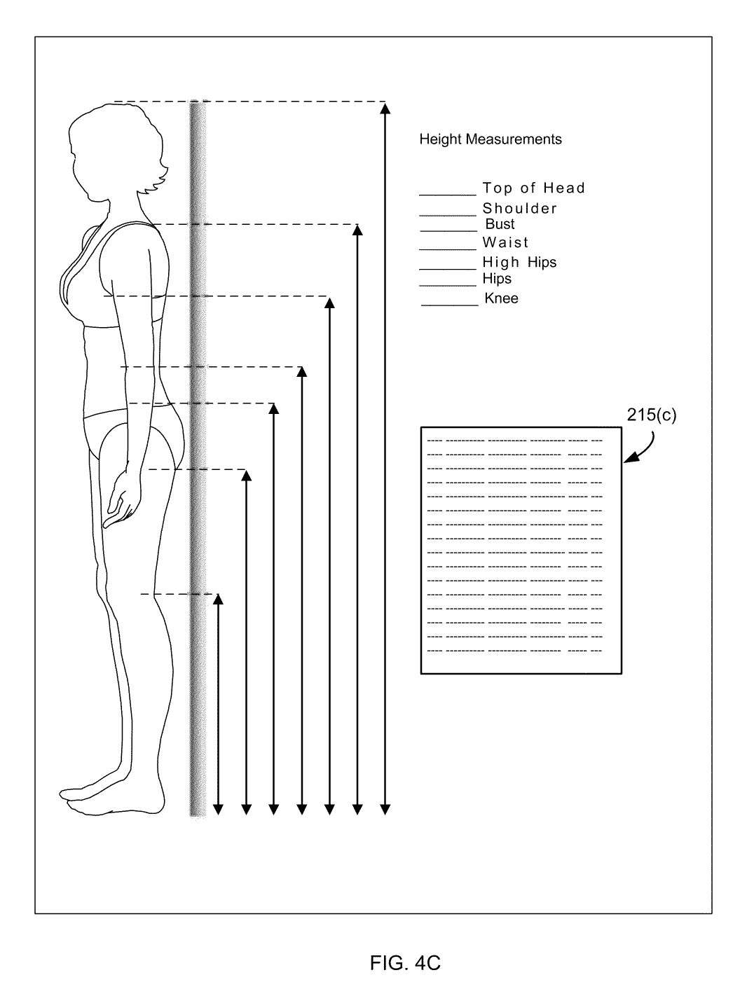

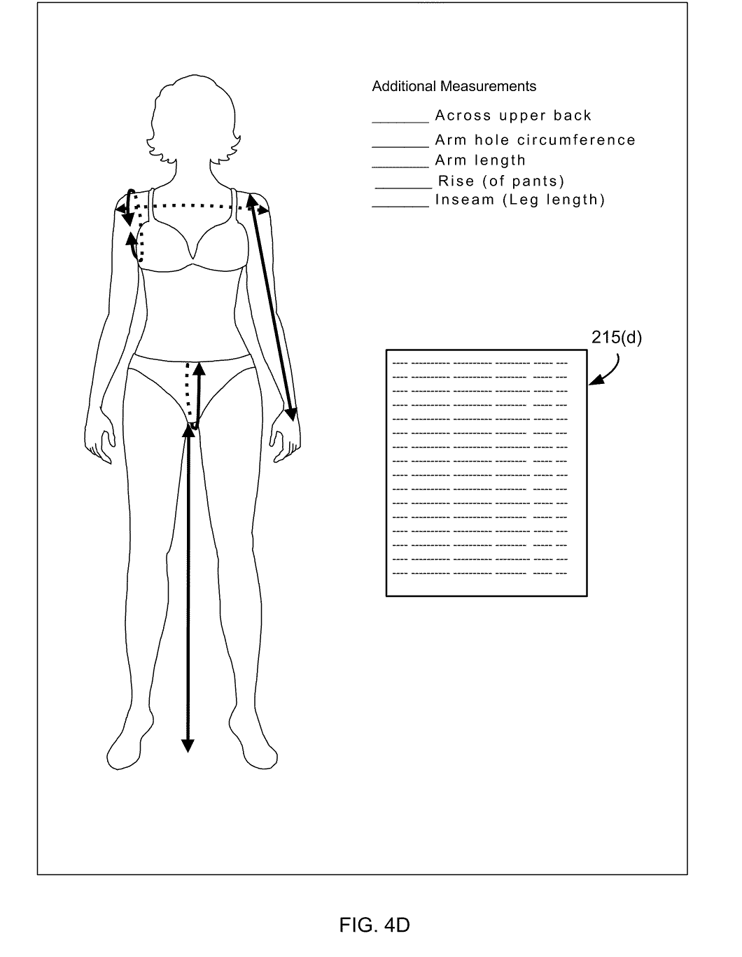

FIGS. 4A-4D depict the positions and techniques for acquiring body measurements to obtain consumer data.

The displays of FIGS. 4A-4D might include instructions to the reader, as instruction blocks 215(a), 215(b), 215(c) and 215(d). Examples of instruction blocks are:

215(a) in FIG. 4A:
Measure the CIRCUMFERENCE of your body at various points.
Shoulders: Measure around shoulders, just below the shoulder joint, going outside your arms at the widest point.
Bust: Measure bust at fullest point and straight across back.
Waist: Measure around torso at your waistline.
High Hips: Measure over top of hip bones, 2″-4″ below waist.
Hips: Measure at the fullest part, usually 7″-9″ from waist.
One Thigh: Measure at the fullest part of one thigh on one leg (your choice).
Upper Arm: Measure the circumference of the thickest part of your upper arm (that bicep muscle!).

215(b) in FIG. 4B:
Measure the FRONT OF YOU from the middle of one side to the middle of the other only. It helps if you are wearing lightweight, form fitting clothes with side seams to help locate the side of your body.
Front of Shoulders: Measure from mid point of upper arm just below the shoulder joint to the same point of the opposite side, crossing the front of your body.
Front of bust: Measure from as close to middle of one side of your body to the middle of the other crossing over the fullest part of your bust.
Front of Waist: Measure from middle of one side to the middle of the other at your waist.
Front of High Hips: Measure over top of hip bones, 2″-4″ below waist.
Front of Hips: Measure from the middle of one side to the middle of the other at the fullest part of your hips, usually 7″-9″ from waist.

215(c) in FIG. 4C:
Measure the HEIGHT of the following by taping or attaching a measuring tape to the bottom of a wall or doorway (floor—measurement zero) to measure the heights. A book, ruler or straight edge can help. This will give a vertical silhouette.
Top of head: Measure from the floor to the top of your head.
Should height: Measure from the floor to the top of your shoulder joint.
Bust height: Measure from the floor to the fullest point of your bust.
Waist Height: Measure from the floor to your waistline.
High hip height: Measure from the floor to your high hip (your hip bone, usually 2″-4″ below your waist).
Hip height: Measure from the floor to the fullest point of your hips.
Knee height: Measure from the floor to the mid-point of your knee.

215(d) in FIG. 4D:

Almost done, just a few more!
Across upper back: Measure across your upper back from end of shoulder joint to end of shoulder joint. Or, for a shortcut, use a favorite jacket, measuring from shoulder seam to shoulder seam.
Arm hole circumference: Measure top of should under arm and back around to the top of the arm.
Arm length: Measure from the middle of the shoulder joint to the wrist joint, with slightly bent elbow.
Rise (of pants): Start at middle for your waist in back, pass tape measure between your legs and up to the middle of your waist in front. Do not pull tight on this measurement, and don't make it too loose. Keep comfort in mind and make sure you are measuring your body accurately. A shortcut is to measure your favorite pair of pants.
Inseam (leg length): Measure from the crotch to the floor on the inside of your leg. Or, for a shortcut, measure the inseam of your favorite pair of pants.

Human body shapes are defined by a body shape defining process 212. Similarly, the same sample body measurement data form the inputs of a body height defining process 214. Definitions of body shape codes and body height codes are stored in the definitions & rules database 139c as maintained by database server 138. Thus these body shape codes may then be assigned by the categorization process 220. A similar or identical set of measurements may be used by the categorization process 220 when collecting garment measurement data for any individual garment via the manufacturer module 120. A garment type definition table specifies the measurements, tolerances and order of calculation to be used by the measurement filter 232 during a match assessment 230. Garment type definitions together with their fit rules and tolerances are stored in a definitions & rules database 139c as maintained by database server 138. The Fashion rules, tolerances and fashion suitability tables are stored by the definition process 210 in a definitions & rules database 139c as maintained by database server 138.

### Categorization Process

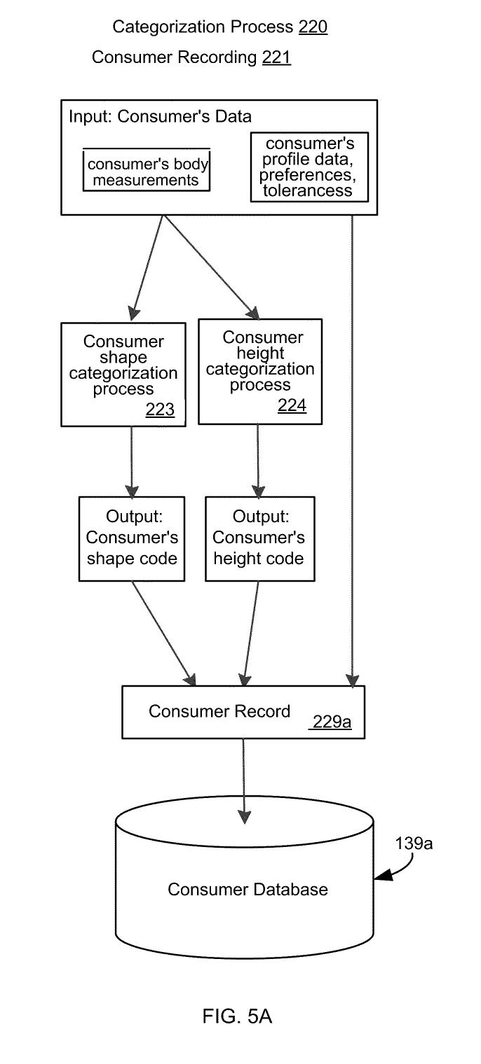

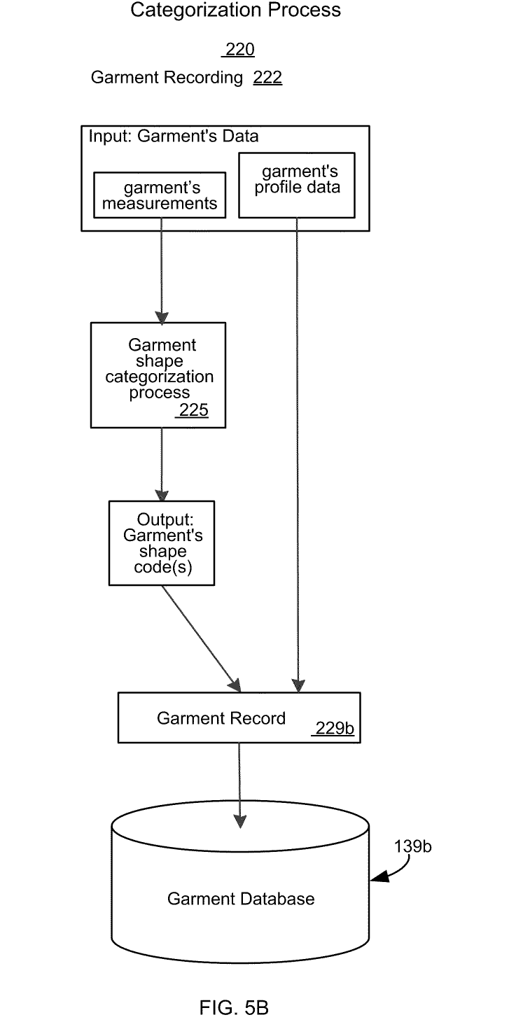

As embodied herein and depicted in FIGS. 5A-5B, a categorization process 220 has two sub-processes: consumer recording 221 (FIG. 5A) and garment recording 222 (FIG. 5B). A consumer record 229a is data describing an individual consumer. A garment record 229b is data describing an individual garment, including its measurements and profile, e.g., its color, fabric, tolerances, etc. Garments may be sewn clothing items such as dresses, coats, pants, shirts, tops, bottoms, socks, shoes, bathing suits, capes, etc., but also include worn or carried items such as necklaces, watches, purses, hats, accessories, etc. The categorization process treats either a clothing item or a fashion accessory as a garment having a garment record 229b that may include measurement and/or profile data as taught in Wannier I, Table 3 Garment Measurements and Table 4 Garment Profile Data. An example of an accessory's garment profile data are shown below in Part 4 Handbag of Table 1—Outfit Template. The consumer records 229a are stored by the categorization process 220 in a consumer database 139a, while garment records 229b are stored in a garment database 139b. In addition to the thirty-two data points given as an example consumer profile in Wannier I, Table 2, any number of different or additional data points may describe the consumer, including but not limited to hair color, face shape and other body, style or preference details. The consumer and garment databases are maintained by database server 138.

### Consumer Recording

An individual consumer's body measurements, such as those depicted in FIGS. 4A-4D, are input into a consumer shape categorization process 223. The resulting shape code is assigned to the consumer and stored in her record 229a. A consumer height categorization process 224 calculates a consumer's height code. The height categorization process is used to assign a height code to a consumer. The assigned height code can be stored in the consumer's record 229a.

### Garment Recording

The manufacturer module 120, described herein, supplies the garment measurements and profile data that form the inputs of the garment recording process 222. Referring again to FIGS. 5A-B, a garment's measurements are inputs to a garment shape categorization process 225. The resulting shape codes are assigned to the garment and stored in its garment record 229b. The consumer records 229a can be stored in a consumer database 139a, while garment records 229b can be stored in a garment database 139b. The consumer and garment databases can be maintained by database server 138.

### Match Assessment Process

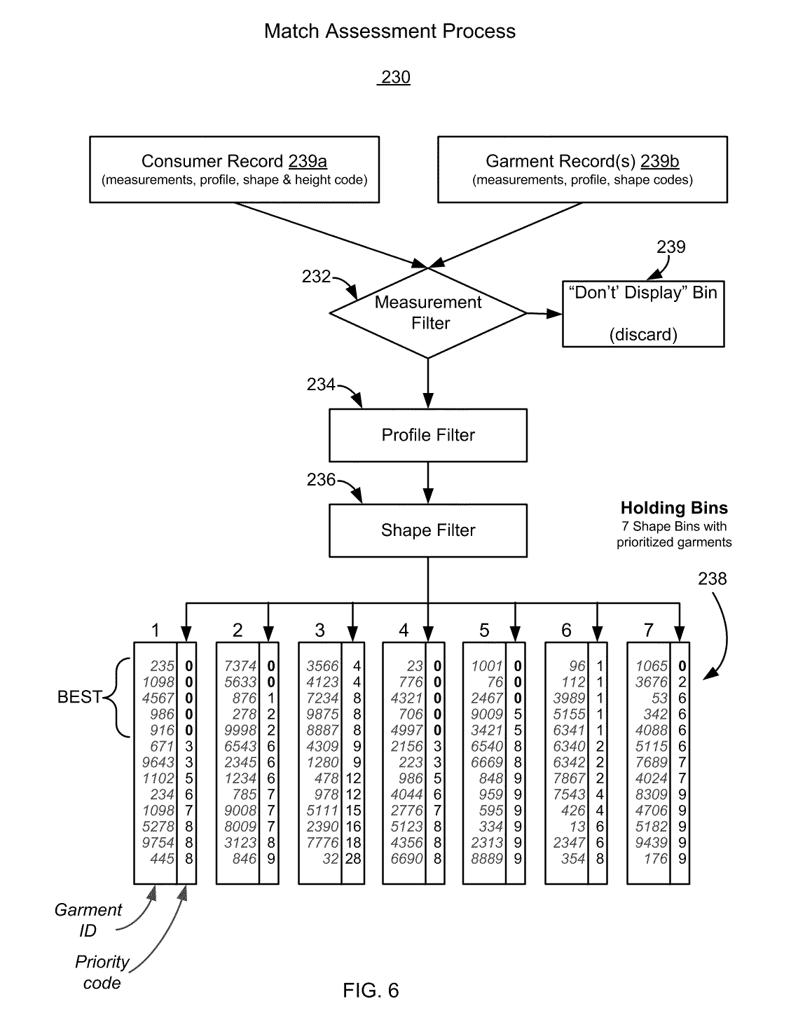

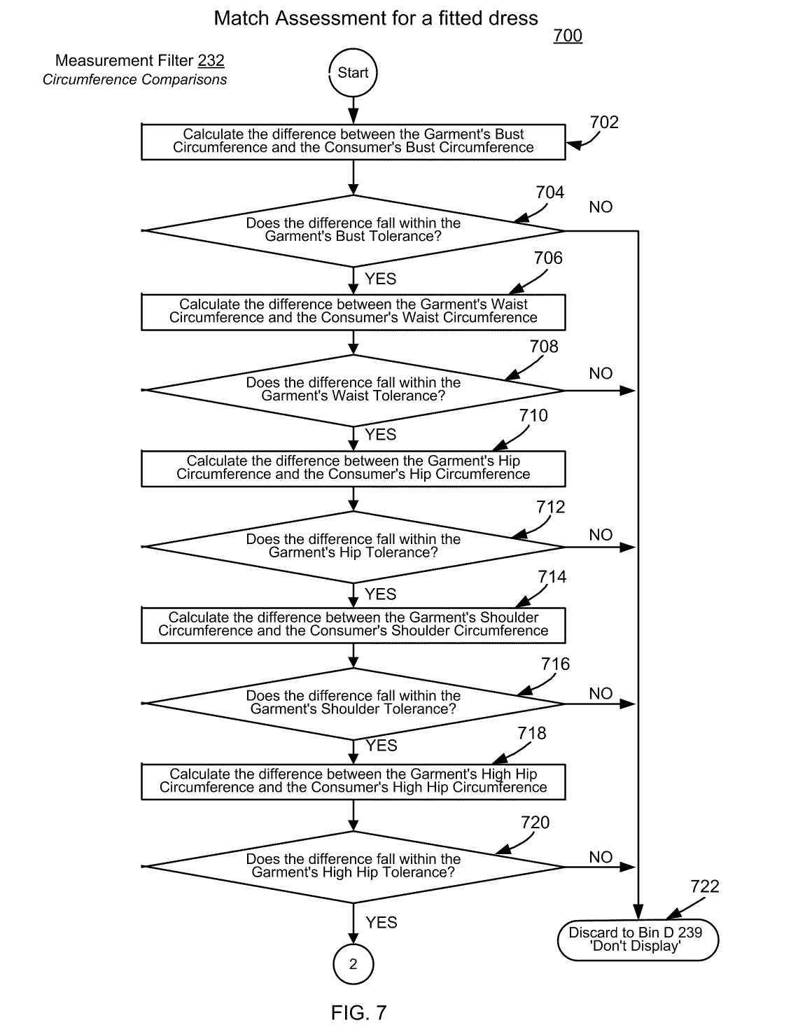

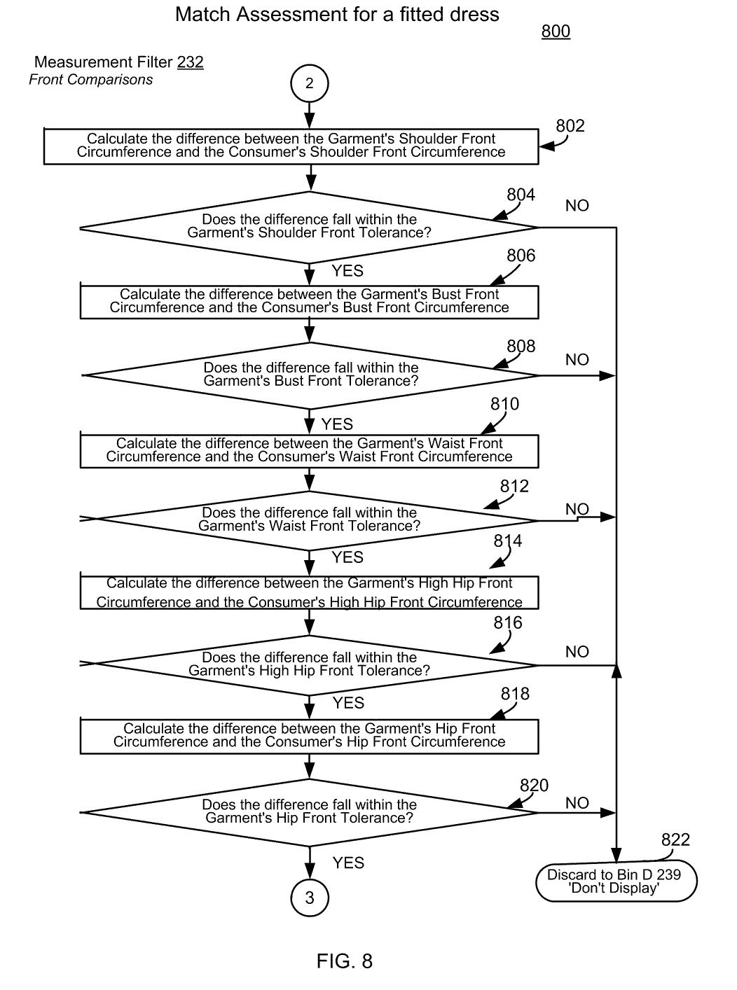

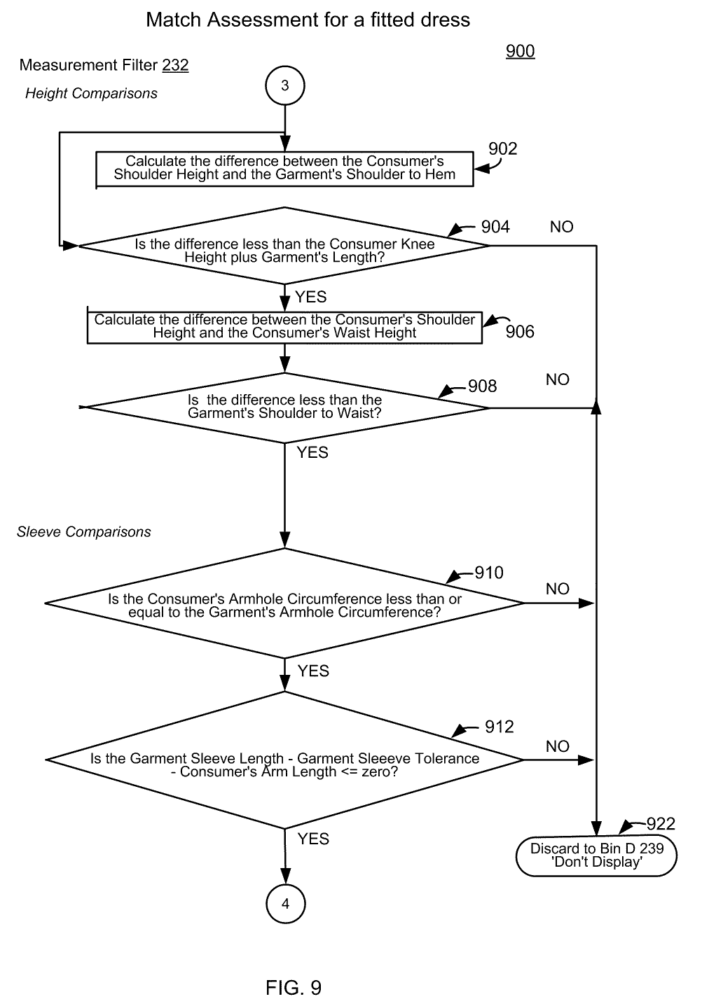

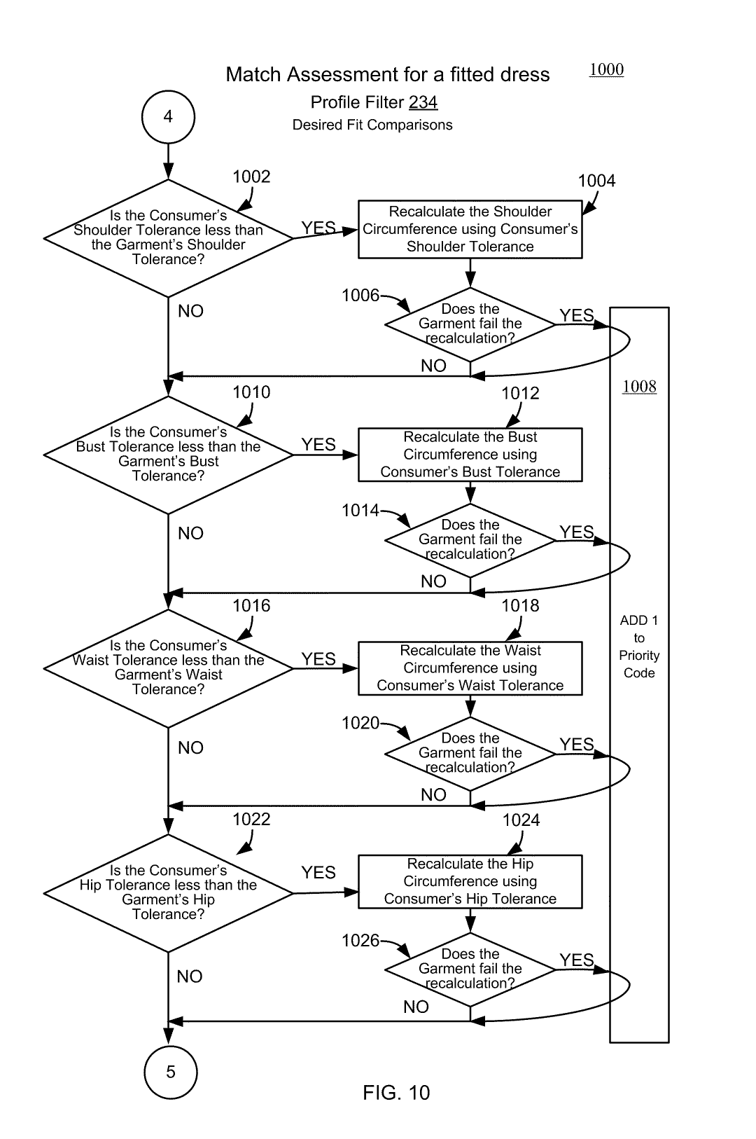

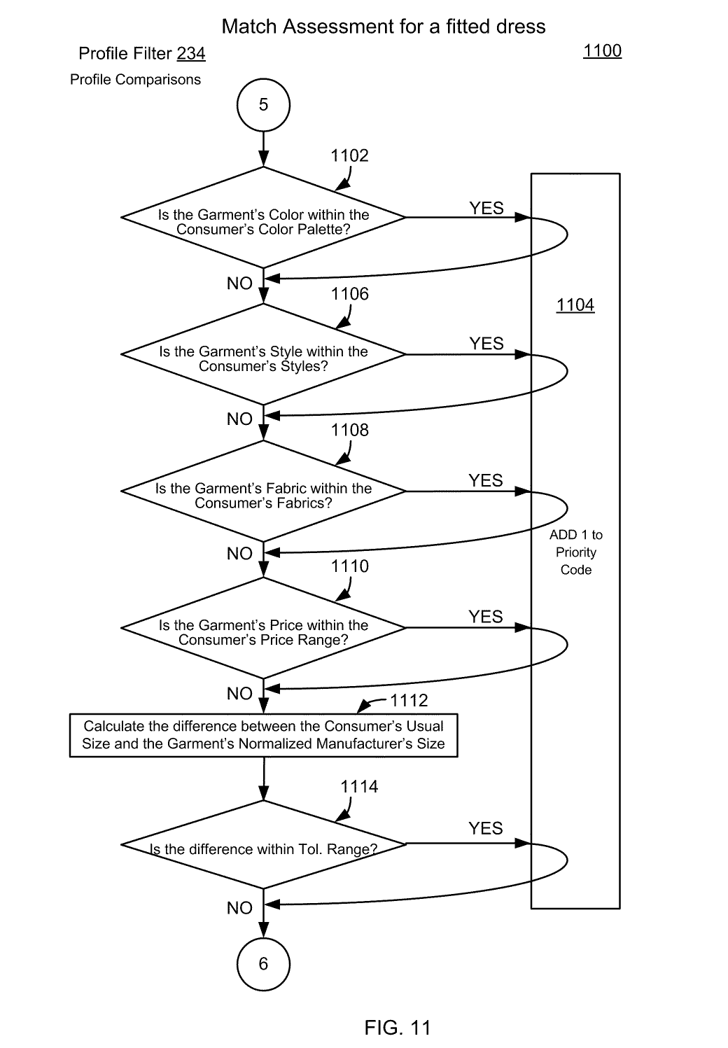

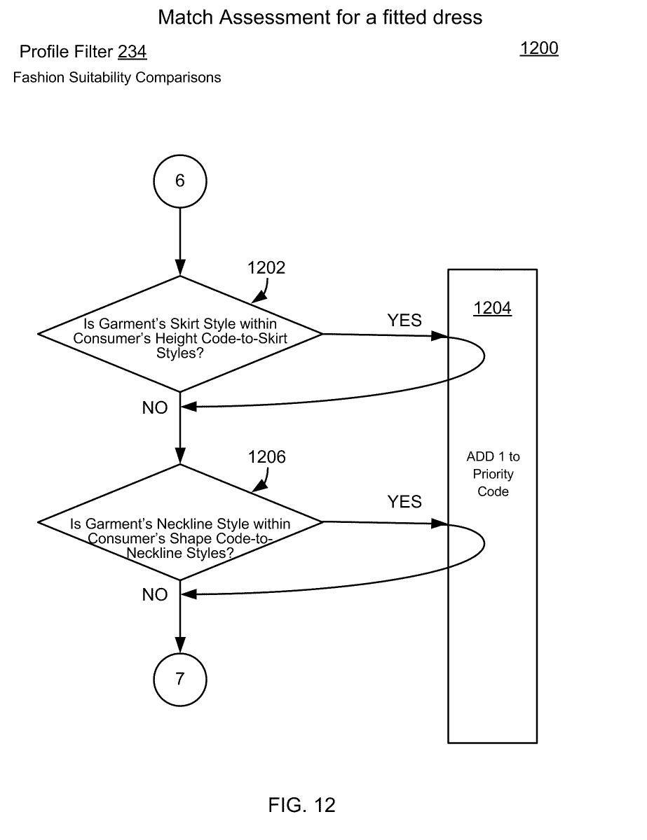

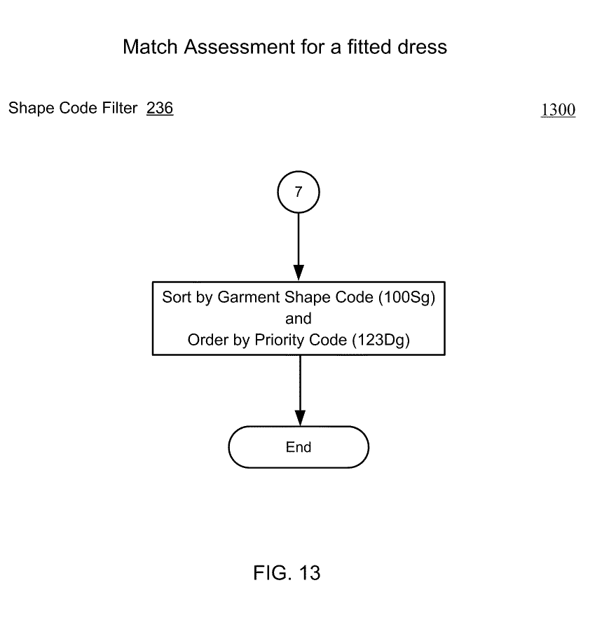

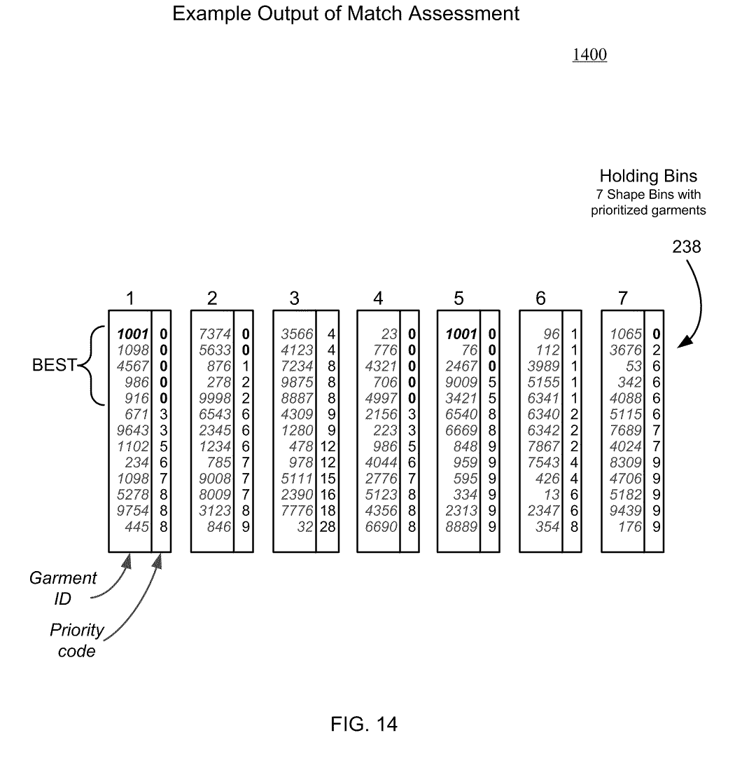

FIGS. 6-14 depict a match assessment process 230 and various elements thereof. The match assessment process treats both sewn clothing items and fashion accessories as garments. Thus it matches individual consumers with individual clothing items or individual accessories in the same manner and with equal efficacy. Further details of match assessment processes are taught in detail in Wannier I, II and/or III.

### Personalized Shopping Process

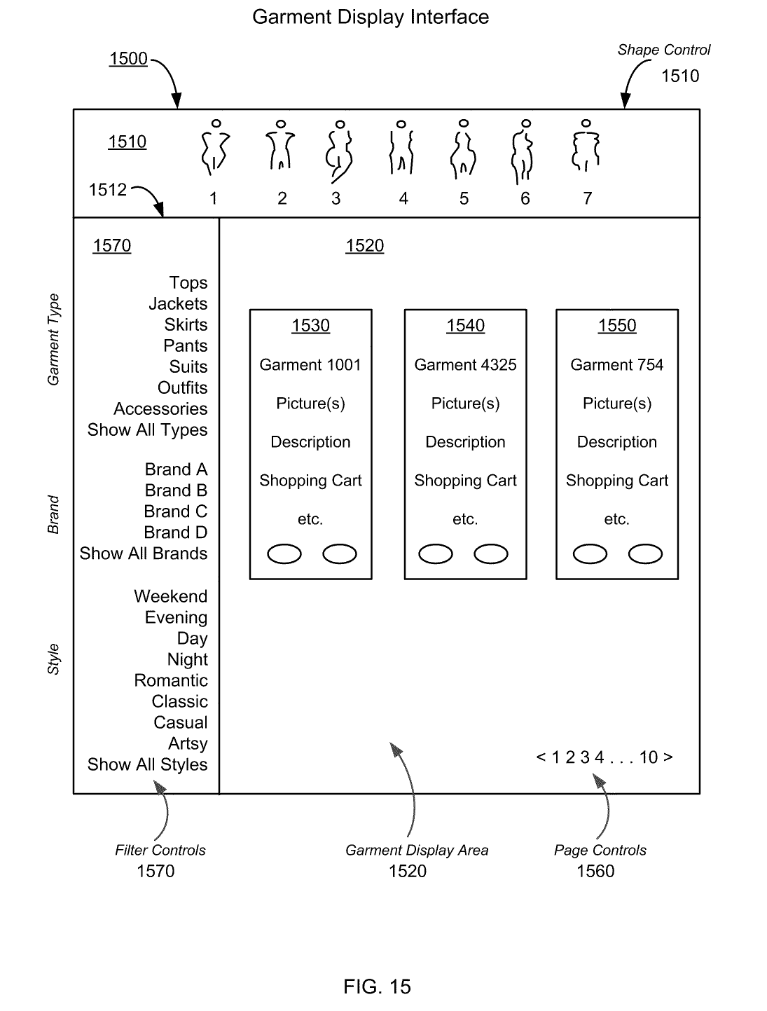

A personalized shopping process 240 presents a consumer with her personal online clothing store. In one embodiment, the consumer is presented with a personal store, which shows the customer garments, outfits and complementary accessories that match the customer's measurements, body shape, height code, personal preferences and fashion styling, that will fit her and flatter her as determined by the fashion suitability rules. In one embodiment, the results of a match assessment 230 of multiple garments and outfits may be displayed to the consumer using a graphical user interface (GUI) 1500 as depicted in FIG. 15. Further details of a personalized shopping process that might be used as the base for the present invention are taught in detail in Wannier I, II and/or III.

### Personal Mall

In addition to providing the consumer with a personalized store, elements of the systems described above can be expanded to cover a personal mall, wherein filtering is done as above, but over multiple online retail outlets. The particular retail outlets that are part of the system would depend on a number of criteria and the operator of the matching system might provide that access in exchange for commissions, as well as upselling, cross-marketing and providing other useful features for the consumer. An advantage to those retailers who join the personal mall and provide a virtual storefront is reduced return rates. With proper arrangement of the personal mall, each retail outlet can present its own brand and may be the shipper that ships the products directly to the consumer.

Among other teachings, a multi-partner shopping system is described that can be used for shopping for clothes and accessories, shoes, purses, and/or other products that include or embody notions of fashion and/or style. In one implementation, content is maintained on servers and served to browsers on request, with some content generated on the fly. The presentation of this material, collectively, by a server having access to the content is often referred to as a “website”, although the “location” of such a site is virtual and often in the minds of the users. Nonetheless, that shorthand is used herein and it should be understood that a website is content served by a physical computing system or a process running on a physical computing system. Likewise, when referring to operations that the “website” does or presents, it should be understood that those operations are performed by a processing device, processor, etc. executing instructions corresponding to the operations or perhaps specialized hardware, firmware or the like.

Online can refer to electronic communications and/or remote access of one computing system or device by another computing system or device, often those having client-server relationships. The access can be over a network of some sort or another. A common example used herein, but not intended to be limiting, is the Internet.

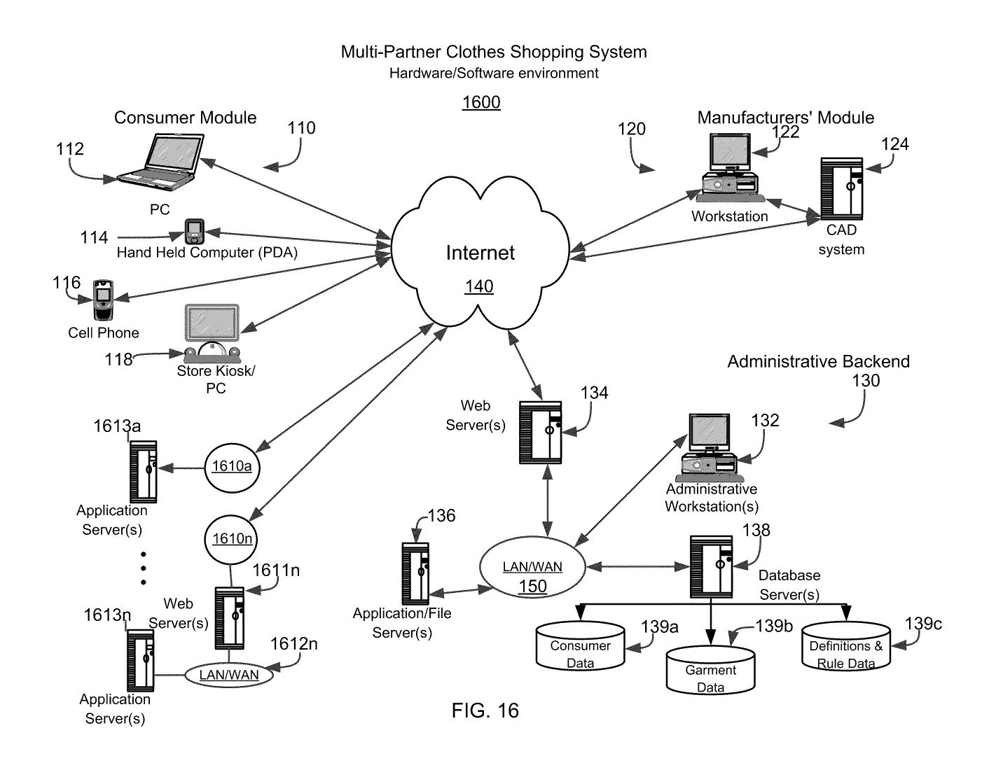

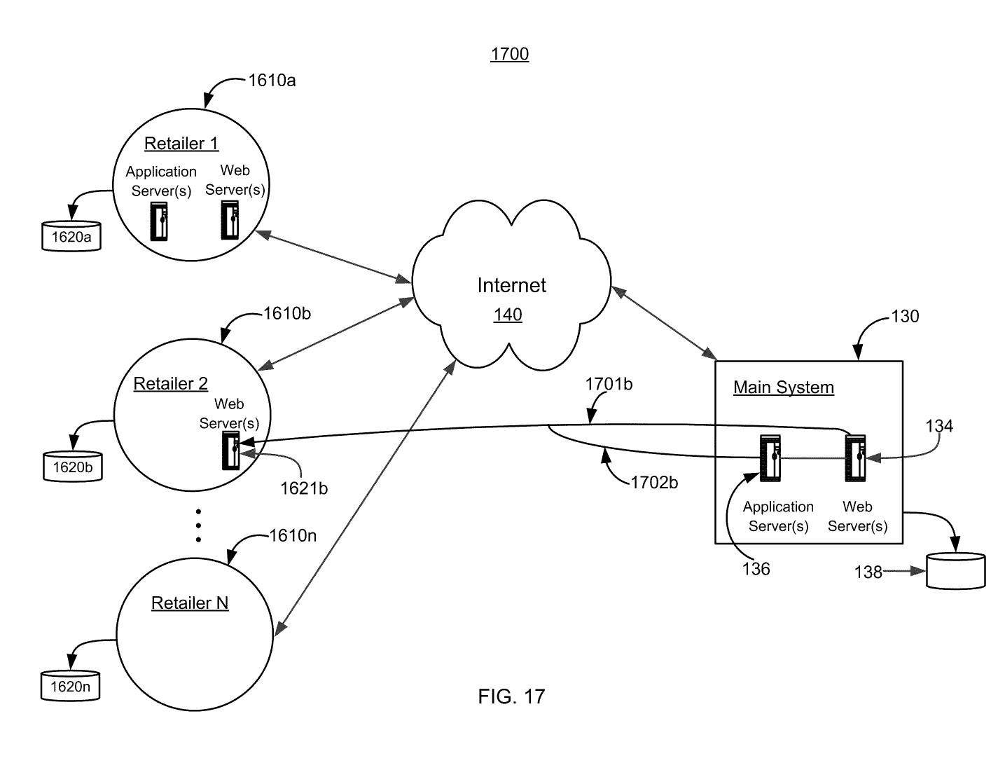

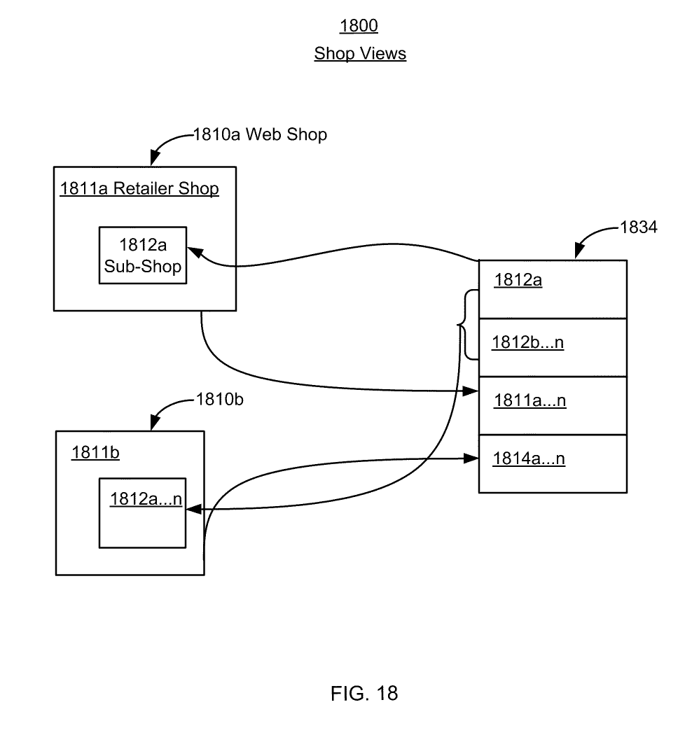

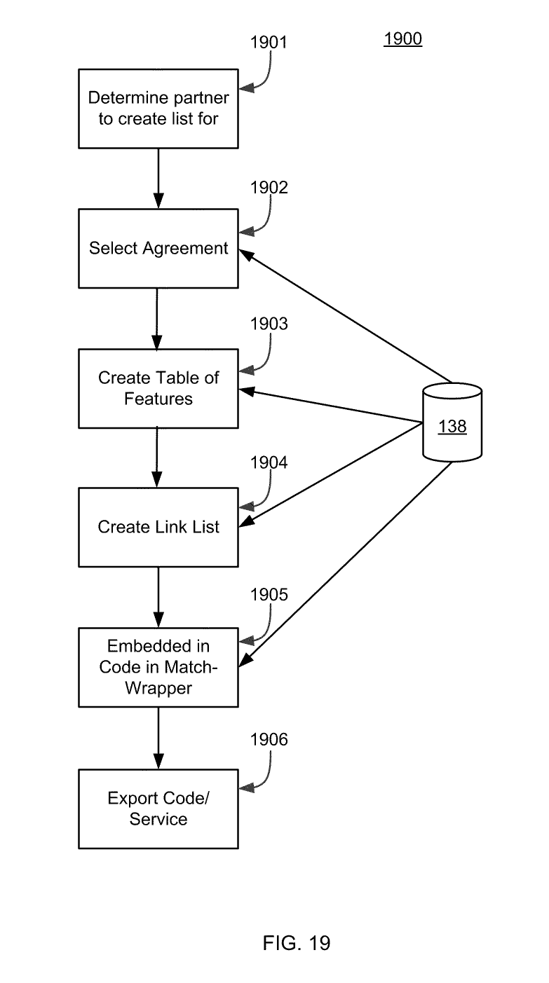

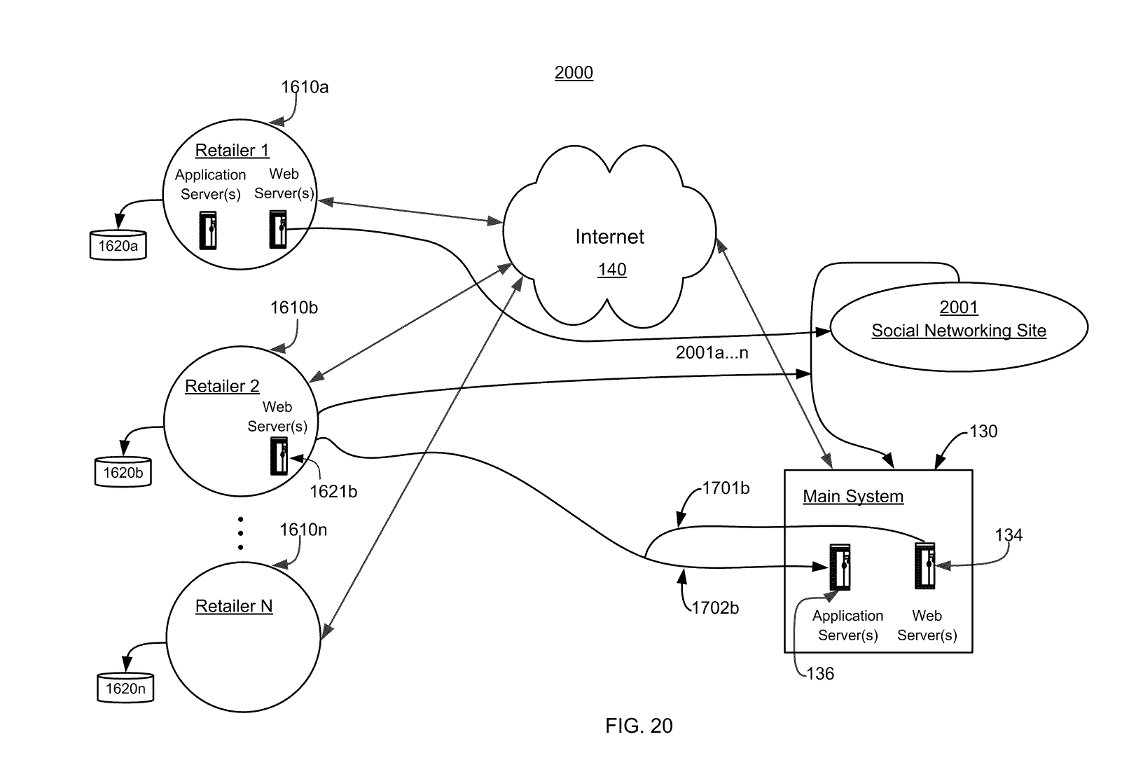

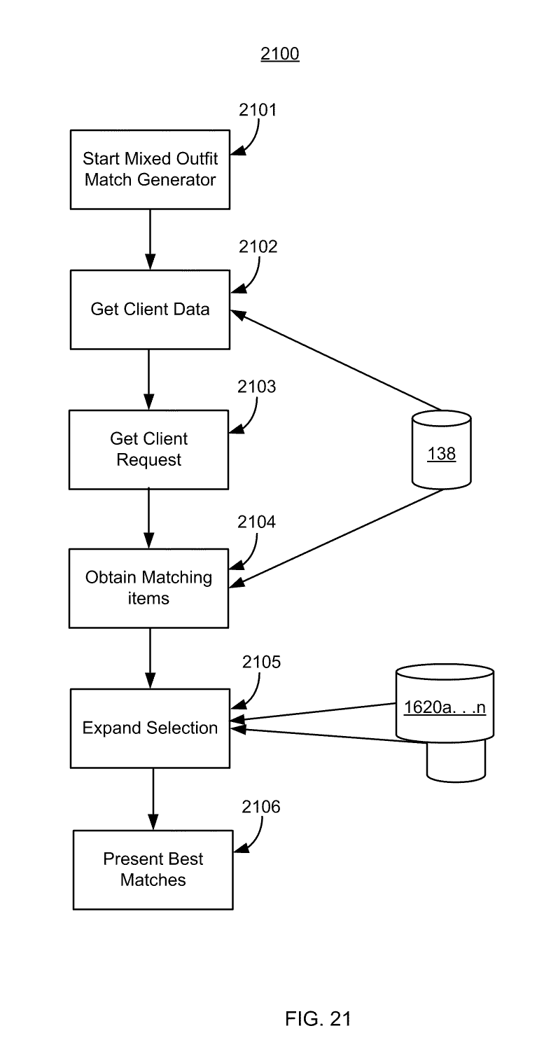

FIGS. 16-21 show an enhanced overview of a multi-partner clothes and accessories, shoes, purses, and all other products that include the notions of fashion and style, shopping system 1600. Further teachings along these lines are provided by Wannier III.

Using such a shopping system, several benefits are provided, such as a system and method for integrating embedded shops on multiple sites, linked to a virtual personal shopping channel where each person can instantly see within their personal shop the clothes and other fashion items that “match” a user's profile and fit and flatter within each node of the network. Those shops can be integrated with social networks and syndication of content for marketing products. The shopping system might generate product combinations from a plurality of inventories at a point of sale for a transaction and a system of soliciting interest in custom-made garments based on user indication, and in some cases including on-line closet representations of consumer-owned items.

The shopping system might allow for shopping of outfits or ensembles of items, allowing users to mix and match on any website or kiosk any part of such an outfit or ensemble, matching to other parts on other websites or items already owned by customer and/or known to the system.

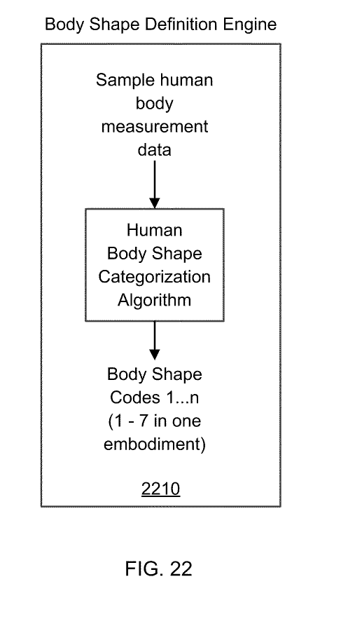

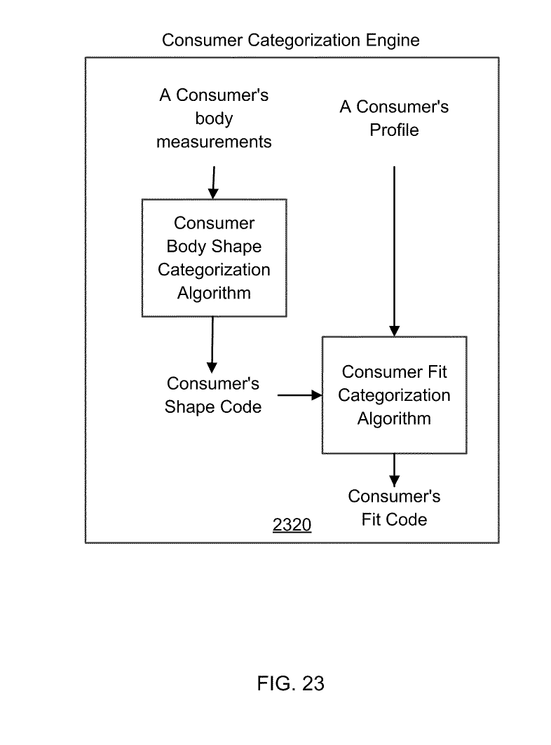

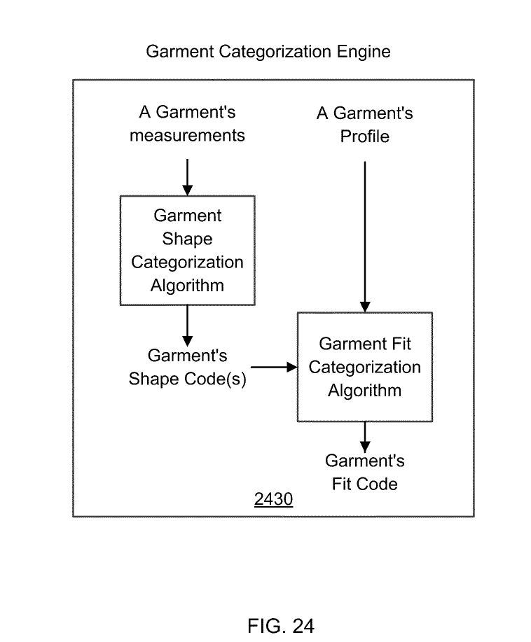

FIGS. 22-24 depict a categorization process 2205 that is described in greater detail in Wannier IV. Individual consumers can be categorized.

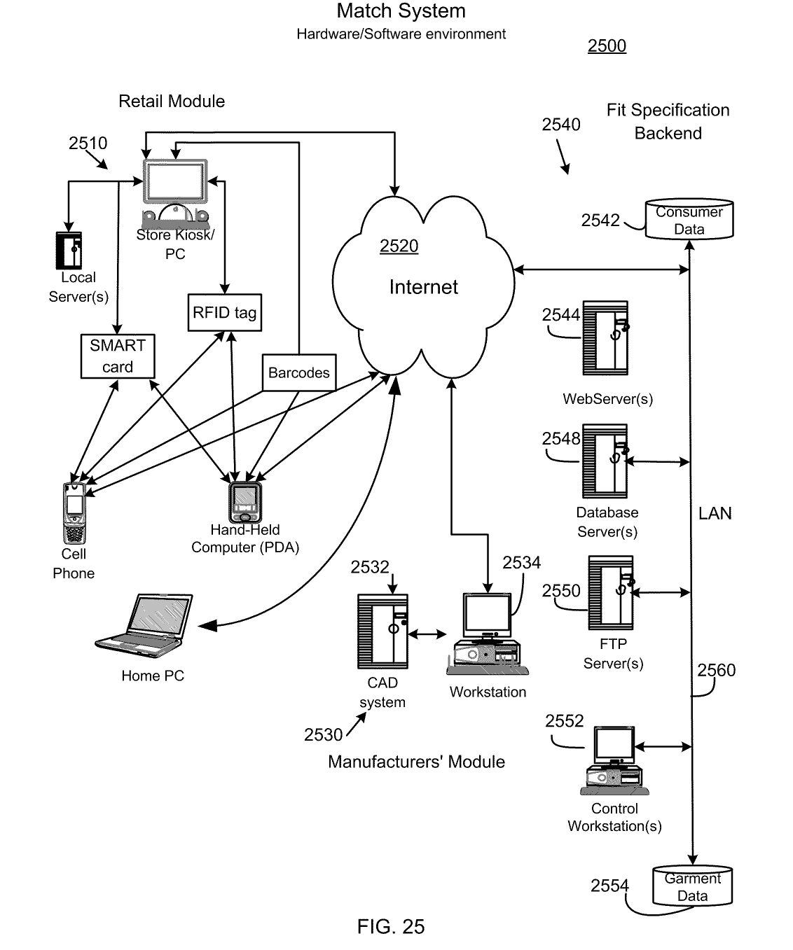

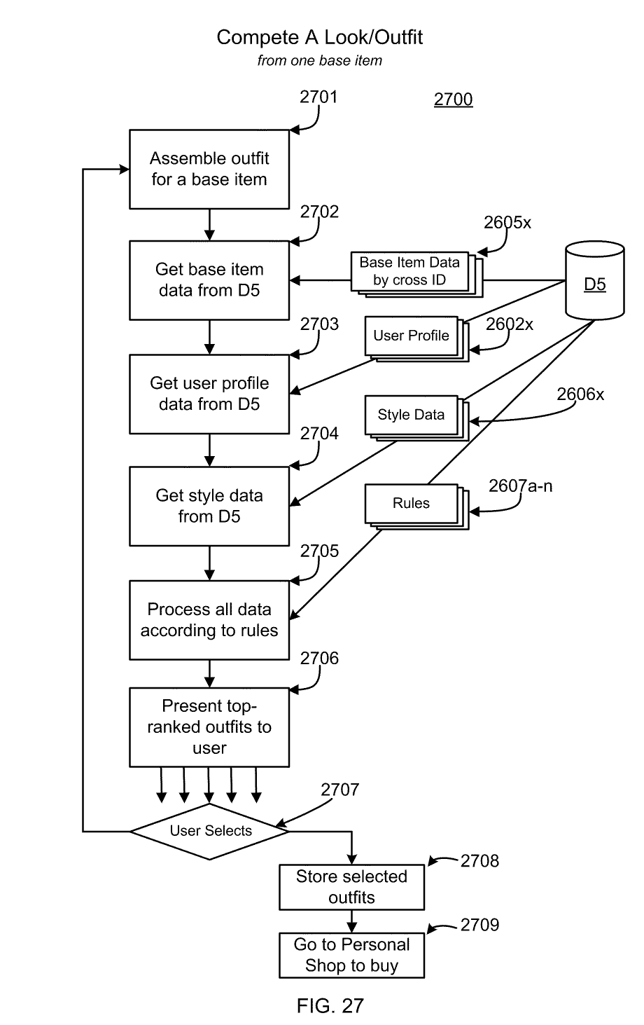

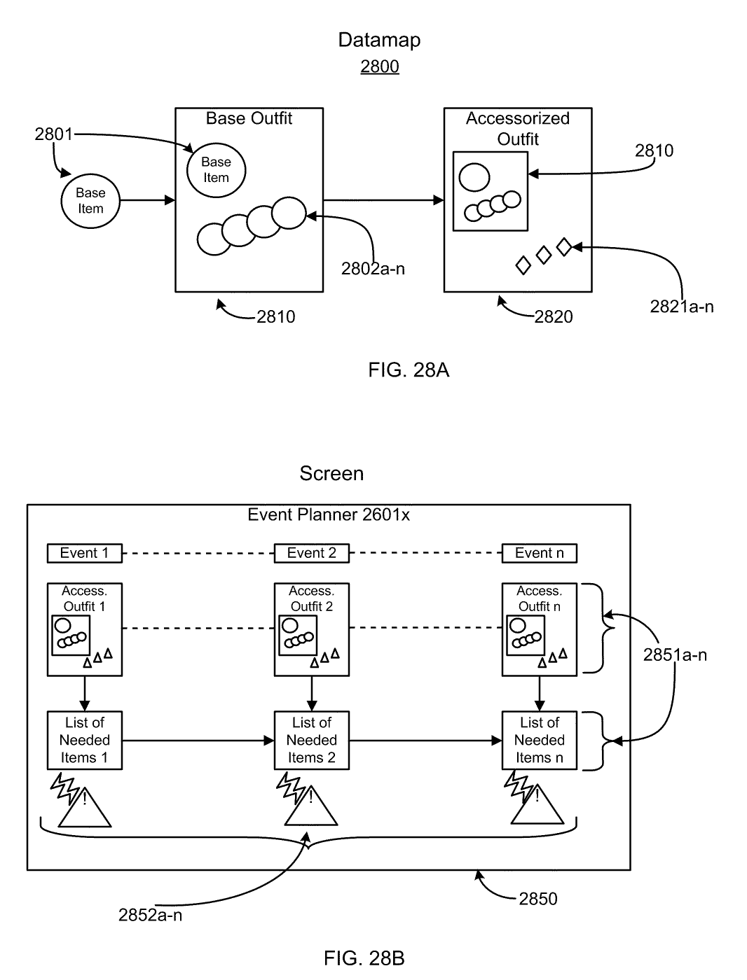

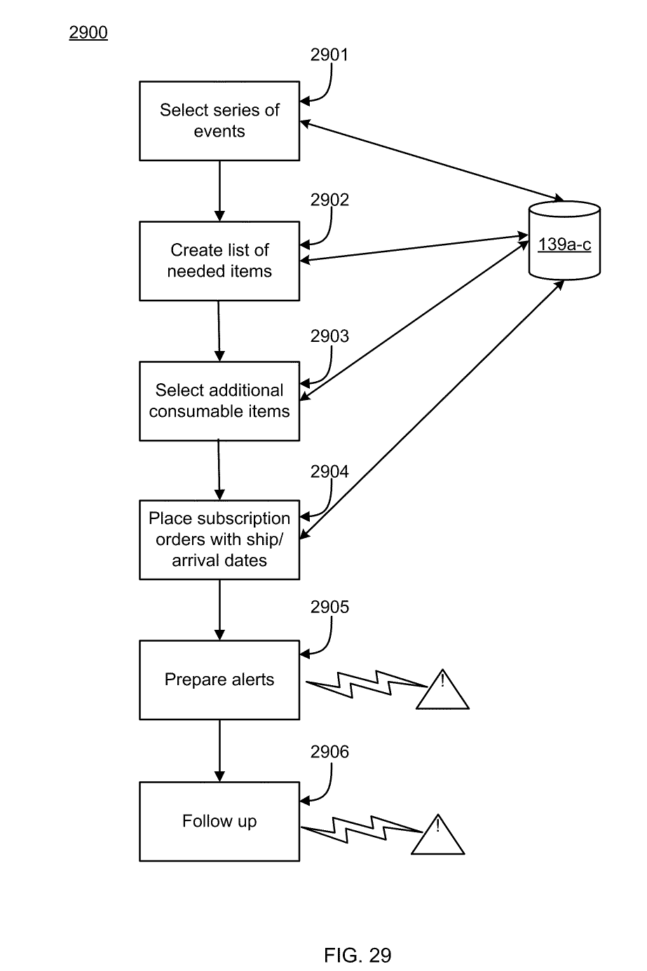

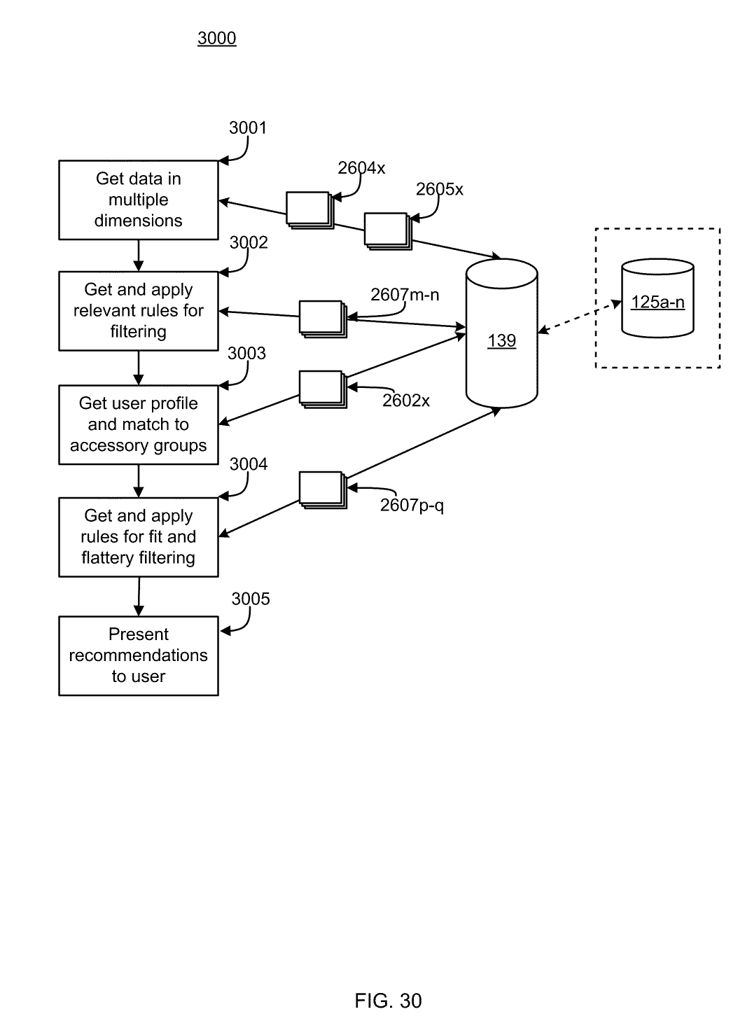

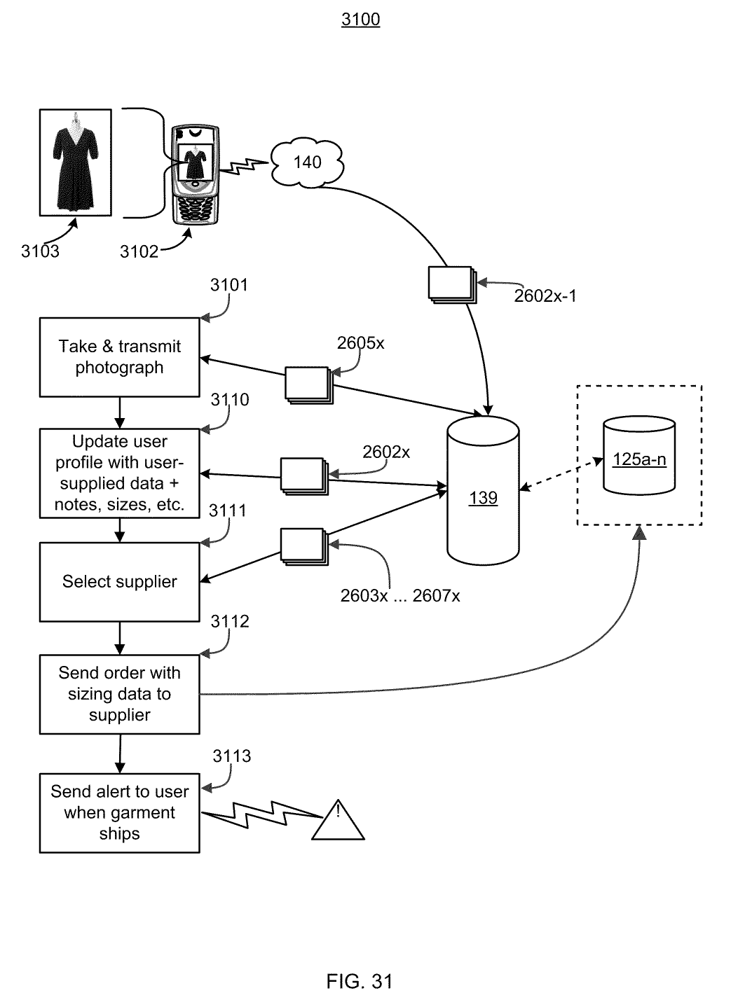

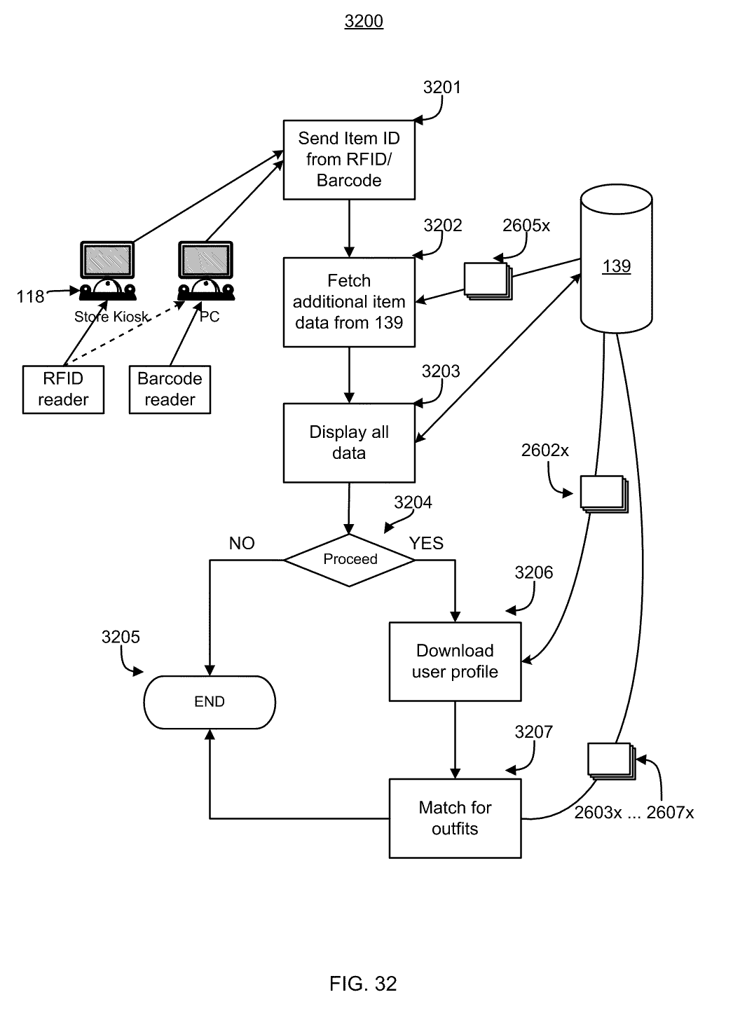

FIGS. 25-32 shows a match system 2500 and processes used to enable a shopping process, each described in greater detail in Wannier IV.

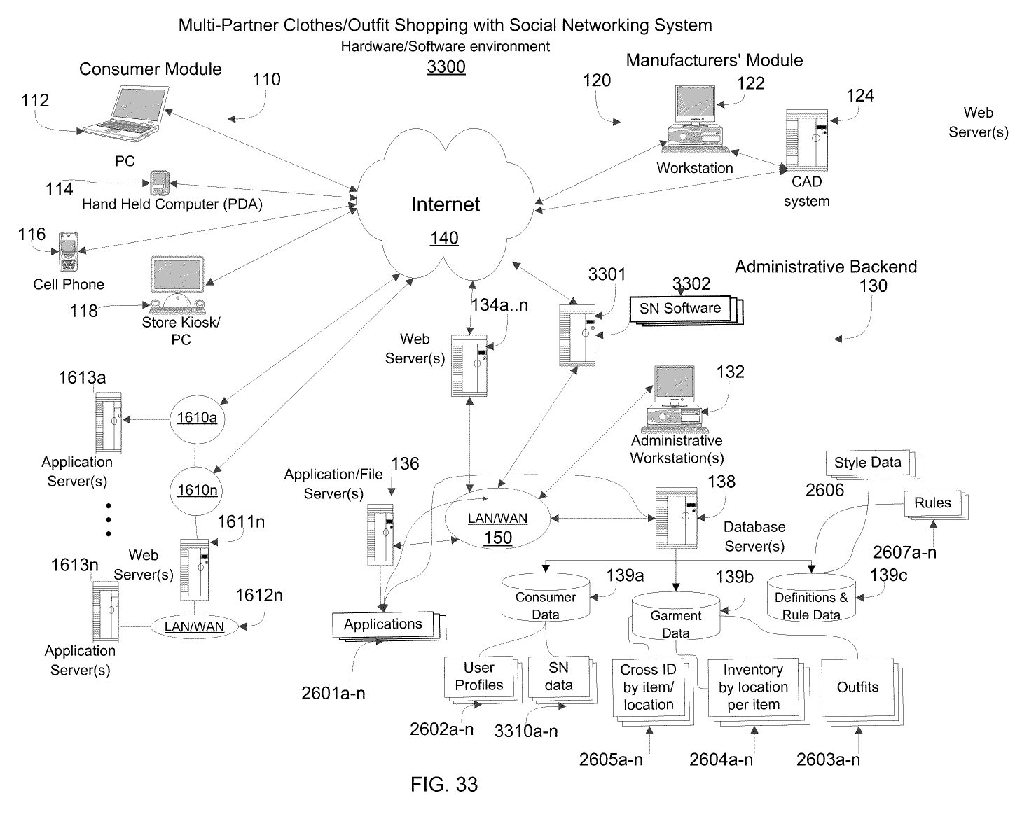

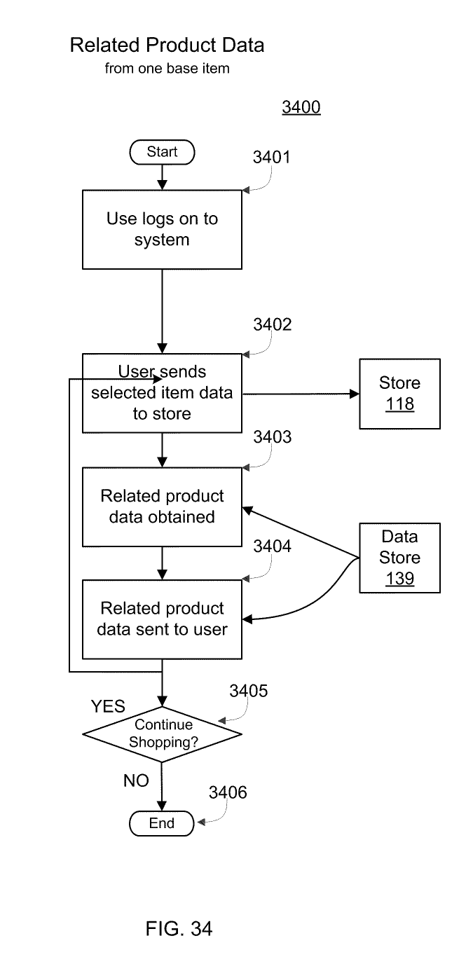

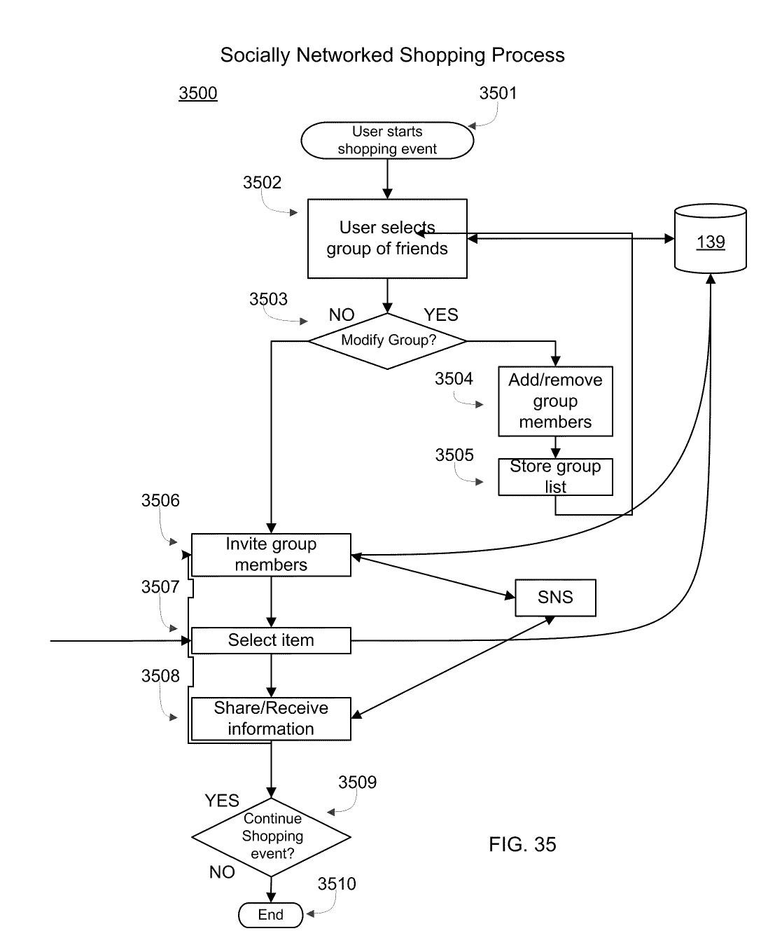

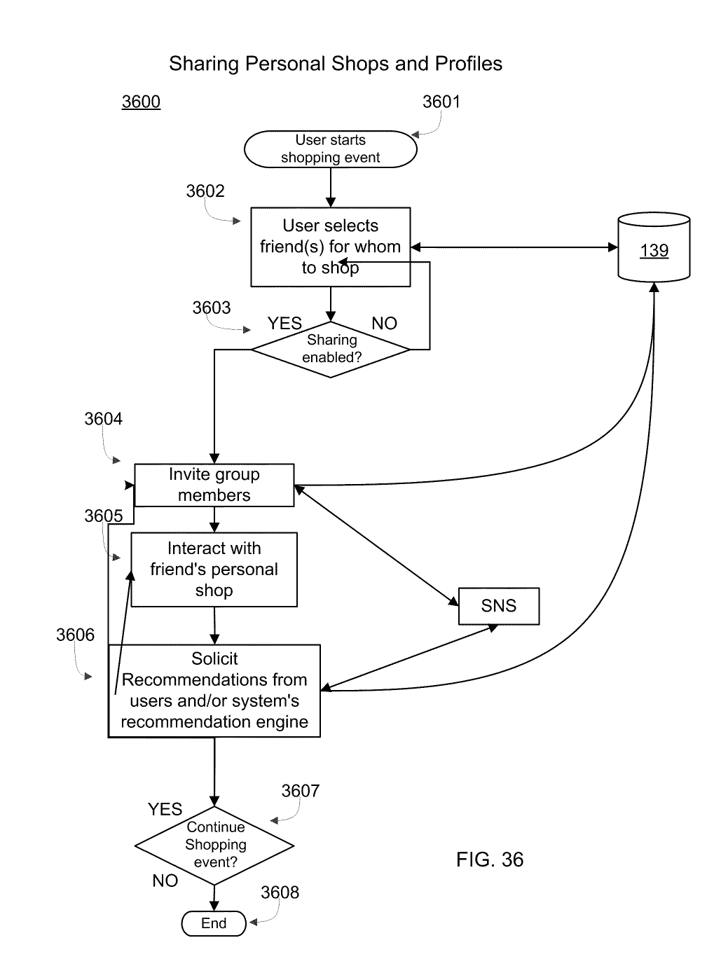

FIG. 33-36 show a socially networked shopping system 3300 that is described in greater detail in Wannier V.

### Distributed Matching Using Image Metadata

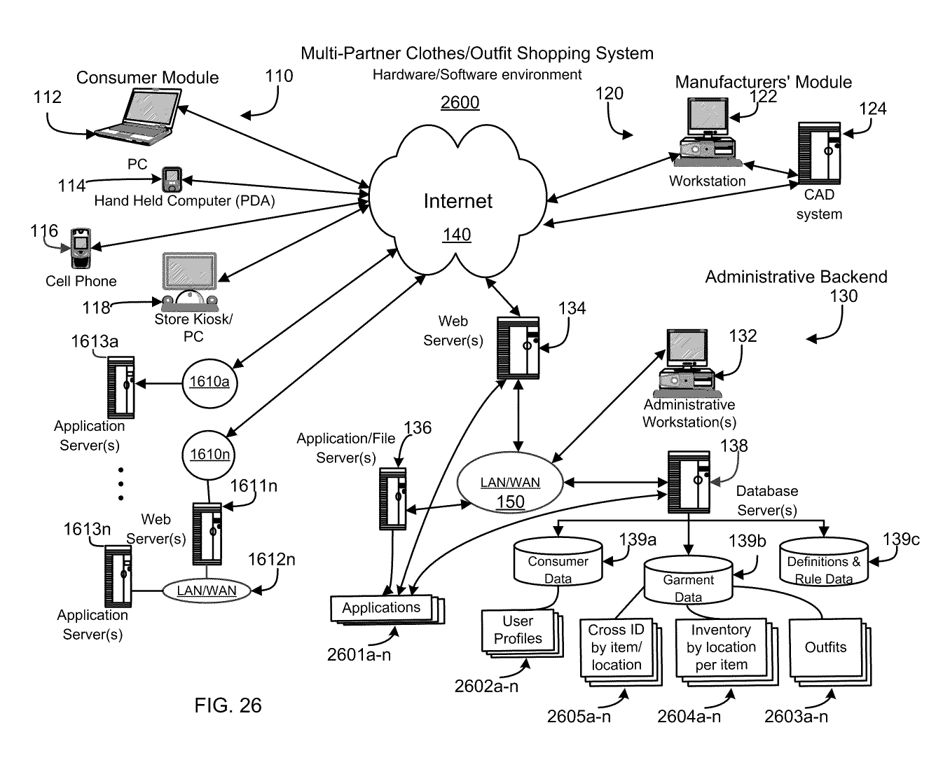

FIG. 33 illustrates an overview of an exemplary system 3300 according to one embodiment of the present invention. In addition to elements described in previous co-pending applications in the descriptions of FIG. 16 and FIG. 26, database server 138 may contain garment images in the data sets 2603a-n, 2604a-n, and 2605 a-n, as well as possibly in other data sets not shown. Various embodiments of image storage can be used, such as data stored electronically in JPEG, PSD, Raw, GIF, TIFF, PNG and other formats. In addition to still images, video images, stored as MPEG-4, H.264, FLV, WMV, MOV, etc., media and/or rich media formats such as Flash SWF or Flex files, etc. can be used. The image storage element may be a bundle of multiple images.

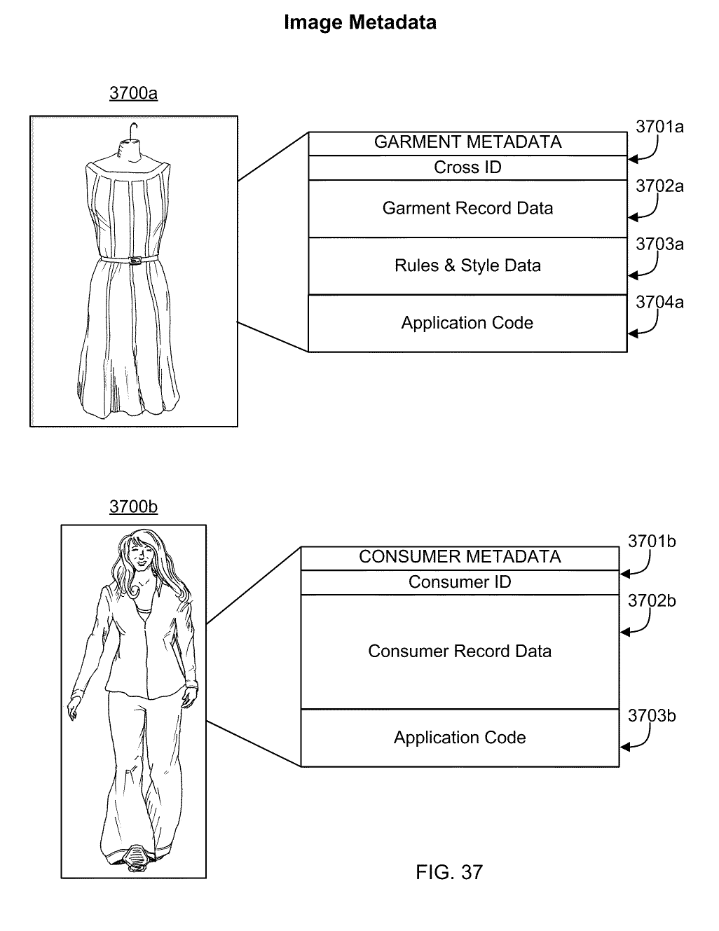

FIG. 37 depicts the metadata structure of a garment image 3700a and consumer image 3700b. In a preferred case, the garment images would be used in conjunction with an ID element, such as cross-ID data set 2605a-n, as the cross-ID offers a unique number across all stores, inventories, and manufacturers. This unique number, discussed earlier, could, for example, be the filename or part of the file name, or in other cases it could be embedded in a tag 3701a in each image, allowing an image to be meta-tagged and uniquely linked to a specific data set. The embedding of metadata can be accomplished using standard methods such as IPTC-IIM, IPTC Core, IPTC Extension, XMP, PLUS, Exif, Dublin Core metadata, or similar and/or proprietary schemes. In other cases, more data than just the cross-ID may be embedded in the image. Metadata 3702a within a garment's image may contain or point to a copy of some, or even all, of the corresponding garment record data contained in garment database 139b.

Metadata 3703a within an image may also contain or point to a copy of some, or all, of the rules and style data contained in definitions & rule database 139c. Metadata 3704a within an image may also contain or point to a copy of some, or all, of the application code 2601a-n contained in application/file server 136. The image(s) metadata may include programming code in a composite format, such as Flash SWF, which is locally executable. Similarly, database server 138 contains images of individual consumers 3700b in the data sets 2602a-n and 3310a-n, as well as possibly in other, not shown data sets. A consumer image may be a bundle of multiple images.

In a preferred case, the consumer images would be used in conjunction with a consumer ID. This unique number, discussed earlier, could, for example, be the filename or part of the file name, or in other cases it could be embedded in a tag 3701b in each image, allowing an image to be meta-tagged and uniquely linked to a specific data set and/or consumer record.

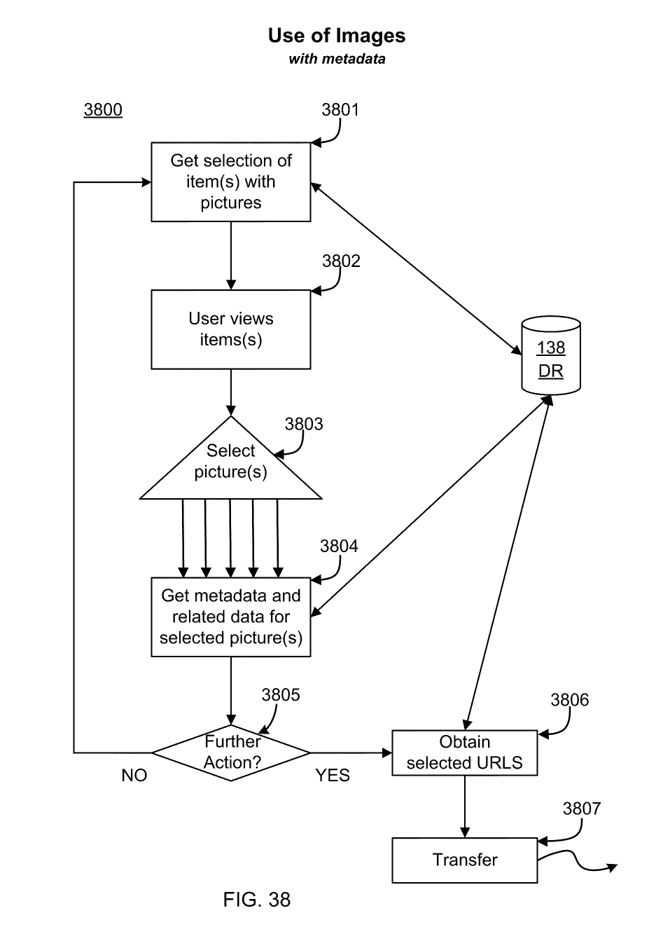

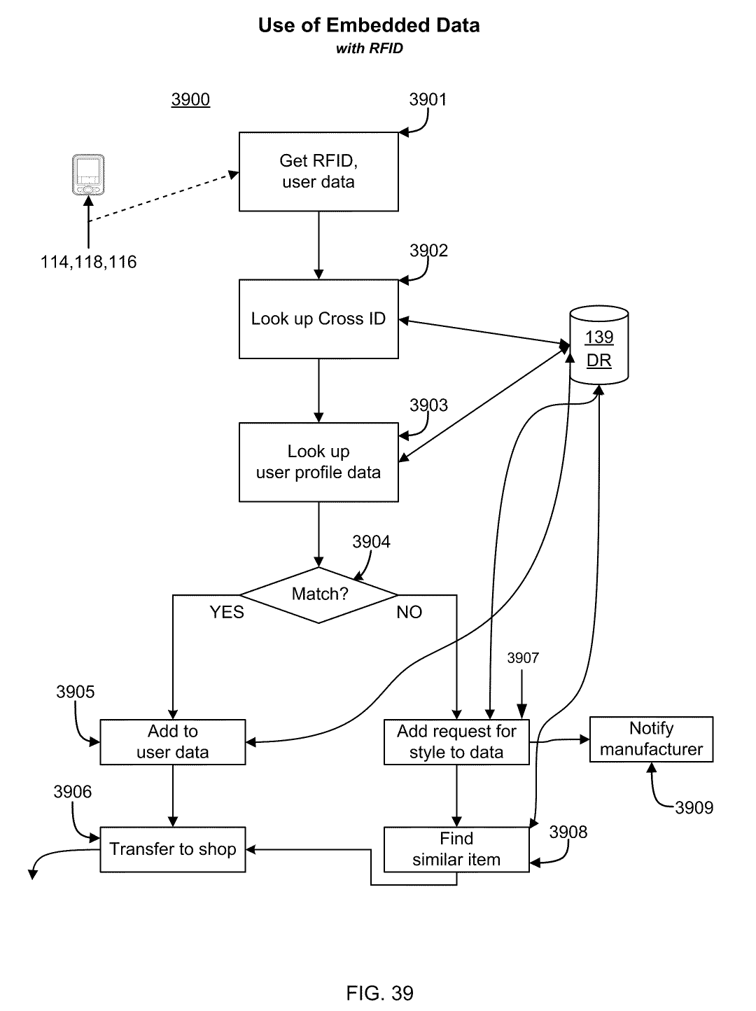

In other cases, more data than just the consumer ID may be embedded in the image. Metadata 3702b within a consumer's image may contain or point to a copy of some, or even all, of the corresponding consumer record data contained in consumer database 139a. Metadata 3703b within an image may also contain or point to a copy of some, or all, of the application code 2601a-n contained in application/file server 136. The image(s) metadata may include programming code in a composite format, such as Flash SWF, which is locally executable. Programming code may also reside locally on a consumer's computing device 110 as a standalone executable application (not pictured). In such cases where a consumer's profile data and a garment's data are available together with application programming code, it is possible through client-side processing to effect a full or partial matching of consumer to garment locally on the consumer's computing device 110, rather than via a remote application server 136. For example, when a garment image is brought in proximity to, or intersects, a consumer image a garment-to-consumer match assessment can occur. The results of the match assessment may be displayed to the user within, or adjacent to, the images themselves or through other visual indicators, such as those taught in Wannier VI. In this way some parts of the processes described below in connection with FIGS. 38 and 39, below, requiring access of data in servers 138 may also occur locally when the needed data and/or code is encapsulated in the images.

In this or a similar manner, images can contain within their objects all of the information needed to perform matching at a distributed location so that distributed matching can occur. Preferably, the information is encoded so that its use is limited to authorized program code so that the information provider can quality control the matching processes.

In other cases, an additional look up may be added (not shown), to anonymize between image data, cross-ID and manufacturer or other inventory numbers. When a user at PC 112 or any other suitable computing device, including but not limited to phones, PDAs etc., clicks on a meta-tagged image displayed through the user's web browser, embedded information about the product is displayed on the user's screen, which information may may be related to the item, and/or it may be related to the user's profile, including wardrobe closet, preferences, etc.

FIG. 38 shows an overview of an exemplary process 3800 according to one aspect of the present invention. A user gets a selection of items with pictures in step 3801. The user may get this information in various different places, such as at the online store, in magazines, in a physical store, in a kiosk, on a cell phone, on a PDA, etc. Once a user views the items in step 3802, he can then select a picture in step 3803. Depending on the picture(s) selected (symbolized by multiple arrows flowing from step 3803 to step 3804), the user can then get metadata and related data based on the metadata for the selected one or more pictures. Often systems allow selection of multiple pictures. Based on the data he has received in in step 3804, the user may request further action, such as to see if the item is a match with his preferences, profile etc., to see if it's available in a slightly modified style, or a different size, or a different color or pattern, etc. At step 3805, the process branches. If the user requests no further action (no) the process loops back to step 3801, where the user may select other items. If the user requests further action (yes), the process moves to step 3806, where additional URLs may be obtained for additional data from data repository 138. It is clear that URLs may be delivered from any of the many web servers in the present system, such as the main web server 134, or any of the various partners' web servers. Then in step 3807 the user is transferred, for example, to a site where the user can shop for the item of interest.

In another instance, garment information could be obtained from video sources. Specifically, coded information about a garment could be embedded into a data structure, and said data structure could then be associated with a video source of a garment. Using standard structures and processes, such as drag-and-drop or specialized software, users could select the garment in a video clip, which could then be transferred to a location of the user's choice. This approach would allow users to get detailed information about a garment they may see on a video source, such as a television program, and to learn more about a garment and how to obtain it.

FIG. 39 shows an overview of an exemplary process 3900, according to one aspect of the present invention, for the metadata use of RFID tags, combined with a user's wish for additional manufacturing of novel size and style combinations. In step 3901, a user may, for example, obtain an ID or other identification via a communication device, such as, for example, a cell phone 116, a store kiosk 118, a PDA 114, etc. In other cases, a user may browse a catalog and obtain an identification therefrom. In step 3902, the system looks up the cross-ID from data repository 139, and in step 3903, the system accesses the user's profile also from data repository 139. In step 3904, the process branches. The system checks to see if there is a match with her preferences, profile, wardrobe, etc. If there is a match (yes), the process moves to step 3905, where the system adds the item to the user data as “viewed,” i.e., the user has shown some interest, and in step 3906, the system transfers the user to a site where the user can shop for the item of interest. If, in step 3904, there is not a match (no), the process moves to step 3907, the user can add a request for the matching size or style data for her profile. This results in storing it in the data repository 138, for example, not just under the user data repository 139a, but also in the garment data 139b and/or definition data 139c. Also in some cases notification is sent to the manufacturer in step 3909. These notifications may be made on an item-by-item basis, or they may be made in a daily or weekly batch, thus allowing manufacturers to see where there is a demand. By offering real-time feedback from the end user to the manufacturers through this system, manufacturers can tweak production more accurately and also respond. In step 3908 the system tries to find a similar item from data repository 139 and then transfer the user to a site where the user can shop for the item. Also in some cases the manufacturer may notify the user that the garment can be custom made and offer the user a time and price for a custom unit and allow the user to place an order for such a custom item in lieu of going to a shop.

It is clear that many modifications and variations of this embodiment may be made by one skilled in the art without departing from the spirit of the novel art of this disclosure. For example, embedded information from an image of a product on an online shop, such as hidden metadata that does not affect the display of the image, may be used. For example, a user may click on the image of a product to see embedded information about the product in the image. In other cases, known preferences, such as garment size and style, may be used to determine which products may meet the needs of a large subset of consumers. The system may gather information about users, such as size and preferences, determine which items those users would be most likely to desire, apply the results of that determination to a different set of consumers, such as a market overall or a demographic subset; and share that information with product makers, such as clothing makers, so that they can best determine which items to manufacture.

The system may include standardized measuring for garments, including points of measurement and ways to measure for high accuracy. A set of standardized measures for a specific garment, for example, a collared shirt, a pullover shirt, etc., is supported by a protocol of specific steps for taking each of several measurements, including, but not limited to, hanging instruction, measurement preparation, and measurement techniques. Then the measurements are documented via a capturing means. Another case may include reducing the number of possible measurements for bodies and garments to a specific, precisely-defined subset, by picking a useful set of measurements for users and garments, which measurements allow comparisons between bodies and garments to be consistently and easily accomplished. A user would follow instructions for measuring garments and for measuring human bodies. After measurements are known, the system would integrate results into a compilation that is understood and agreed upon by all parties using the measurements, to ensure consistency. In a similar instance, the system could use ratios of key portions of pants—measurements of rise and curve—analyzing the measurements by a computerized process to give additional metrics to help evaluate and compare pant products, thus adding to the understanding of the fit characteristics of the pants. In a related case, the system could create specific references for user measurements, such as the measurement from an elbow to a wrist, establishing a common vocabulary around garment measurements that avoid confusion and incorrect measurement when communicating with other parties. In this case, detailed protocols for taking measurements would support the collection of data from the specific measurements, which are referred to by the naming systems to create consistency and reliability.

The system may also include a means for capturing measurement data from external partners, thus facilitating transmittal of accurate data from external partners with a minimum of effort and errors. External partner measurement data would be analyzed by a verification means according to classes of data with predefined characteristics. Errors or inconsistencies would be addressed by an error correction means. The final version of the data would be transmitted to a database for storing information. In some additional cases, the system may use a standard (off-the-shelf type) data structure for management of a class of products, said data structure including methods for encapsulating, encrypting and transmitting information. In some cases, the system may capture a standardized set of measurements as part of a manufacturing process, rather than as a separate measurement activity, to integrate standard measurements into manufacturer processes. The manufacturing process, with key measurement points, could use standardized measurement protocols to unify the measurements across manufacturing lines, manufacturers, locations, etc. In other cases, product specification information may be obtained directly from a designer, which can improve the later decisions about that product, such as quantity to manufacture and design notes. The garment data structure, including but not limited to sections on design, manufacturer, and retailer, is populated by garment information, which is displayed to a user on a graphical interface.

In some cases, manufacturer information about products, such as garment cutting specs, wash recommendations, fabric lot characteristics, etc., that could be used to help with matching products uniquely to users, may be integrated into a product selection process, which is then used to provide product information to consumers. In other cases, parties can obtain information about a representation of a product through a picture of a product, and optionally, a backing database. In this approach, a database is populated with product information, which information is then linked to a picture of a product. When a user selects a picture, product information is returned to the user.

In another case, the performance of a fabric could be determined by judging actual garment fit and shape. For example, a garment may be documented by fabric type, noting the original (unworn) fit and measurements of that garment in a database. Feedback about fit and wear dynamics (e.g. stretching, fading, bleeding, etc.) solicited from users who have worn the garments could be entered into the database. Then an analysis of feedback and original data could generate one or more characteristics, such as “fabric X stretches by 10% at first wear.” Optionally, the resulting fabric characteristics could be integrated into the system to improve recommendations to users.

As has been described herein, shape codes, fit information and other data can be embedded into objects to allow for distributed matching based on data in the object. In addition to embedded data, all or a portion of an application that is to perform the matching can be included with the object. The embedded data can be encoded, compressed or otherwise manipulated, typically in a reversible manner. Embedded data about garments and consumer data (which can be embedded in a consumer image or other consumer object) are used by the matching application to determine which garments would fit and/or flatter the consumer wherein fit and flatter are characteristics determined by the system according to a set of computerized rules, typically encoding for fashion experts' rules.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

1. An online garment selection and acquisition system comprising at least a server computer system that receives requests from client computer systems and/or client devices and responds to those requests, wherein the server computer system is configured to be able to access a database system for reading data therefrom, online garment selection and acquisition system comprising:
a database system that includes a database server and a database for an inventory of garments, wherein the database includes a plurality of type parameters for garments in the inventory and at least at least one fit, shape, preference or style parameter, and wherein the database is distributed over a plurality of database servers;
a network interconnecting the plurality of database servers to the client computer systems and/or devices;
program code for generating metadata for garments to be embedded in images of the garments;
program code for obtaining consumer data including one or more of consumer body shape, consumer proportion, consumer preferences;
program code for filtering the collection of garments according to one or more of consumer preference, consumer size, consumer measurements, consumer shape and parameters of the garments in the database to form a personalized selection of garments; and
program code for generating a presentation of at least one image of a garment to allow for a consumer or consumer representative using the client computer systems and/or client devices to select and/or acquire the garment, wherein the image includes metadata usable for the program code for filtering.

2. The online garment selection and acquisition system of claim 1, wherein the database of garments comprises clothing, shoes, accessories and/or other fashion items that can be grouped into outfits.

3. The online garment selection and acquisition system of claim 1, wherein the client computer systems comprise one or more of in-store kiosks, home computers, general purpose computers, handheld devices, laptop computers, cellular telephones, PDAs, and/or netbook computers.

4. The online garment selection and acquisition system of claim 1, wherein the program code for filtering is program code for filtering based on calculations that estimate a degree to which a garment or accessory might fit or flatter the consumer, given the characterization of the garment or accessory and given the consumer body shape, measurements and/or fit preferences.

5. The online garment selection and acquisition system of claim 1, further comprising a display device as part of the client computer systems, wherein the display device is configured to display the generated presentation and the client system is configured to accept navigation commands from the consumer or consumer representative and to accept input commands from the consumer or consumer representative that signal selection requests.
